(19) United States
(12) Patent Application Publication
(10) Pub. No.: US 2014/0164982 A1
(43) Pub. Date: Jun. 12, 2014

(54) INFORMATION PROCESSING SYSTEM AND INFORMATION PROCESSING METHOD

(71) Applicant: CANON KABUSHIKI KAISHA, TOKYO (JP)

(72) Inventor: Hidekazu Seto, Tokyo (JP)

(73) Assignee: CANON KABUSHIKI KAISHA, TOKYO (JP)

(21) Appl. No.: 14/085,989

(22) Filed: Nov. 21, 2013

(30) Foreign Application Priority Data
Dec. 11, 2012 (JP) 2012-270706

(51) Int. Cl. G06F 3/0488; G06T 11/60

(52) U.S. Cl. CPC G06F 3/04883; G06T 11/60
USPC 715/780; 345/156

(57) ABSTRACT

In order to manage handwritten information written on a paper surface and electronic information input from an information terminal in association with each other, handwritten comment information and electronic comment information are managed as thread information in association with each other. When an object near a comment is imaged (captured), the thread information is superimposed and displayed on the captured image and is extended/displayed toward the object.

### BACKGROUND OF THE INVENTION

1. Field of the Invention

The present invention relates to an information processing system and an information processing method.

2. Description of the Related Art

There is available an electronic bulletin board system (to be simply referred to as an electronic bulletin board hereinafter) which controls the registration and reading of information by many users. The electronic bulletin board is widely used for the transmission of various types of information and communication among users. When using such an electronic bulletin board, the user transmits, via an information terminal, information which he/she wants to register in the electronic bulletin board to a server connected to a network. The server registers the received information in the electronic bulletin board which is managed by the server. The information terminal reads out the registered information and displays it on the display unit of the information terminal. Some electronic bulletin boards can handle not only comments as text information but also images such as photos (see Japanese Patent Laid-Open No. 2001-101114).

There is also available an approximate image detection technique of detecting specific patterns in images. This technique is designed to compare a plurality of feature points of arbitrary images with each other by using a technique of detecting points representing features of images (feature points) and checking the approximation degree between them to detect whether they match each other. It is possible to determine to which registered image an input image is approximate, by registering a plurality of images as search targets in advance and comparing an input image with all of the registered images to check the approximation degrees between them. This technique can be applied to not only an overall image, but also part of the image. Registering a captured image of an object in advance, therefore, enables to check whether a target object exists in the captured image. There is also available a technique of registering, as registered images, both an image of a target object and an image of an object located near the target object upon detection of the object in advance, thereby allowing detection of the target object even if the object does not exist in the captured image (see Japanese Patent Laid-Open No. 2012-63850).

When registering information handwritten on a paper material in the electronic bulletin board disclosed in Japanese Patent Laid-Open No. 2001-101114, the user images the paper material including the handwritten information and registers the captured image in the electronic bulletin board. In this case, when the user additionally inputs information (electronic comment) via an information terminal to add a comment to the information of the handwritten portion (handwritten comment) depicted in the image registered in the electronic bulletin board, the electronic comment is added to the above image. However, an image may include the information of a plurality of handwritten portions (a plurality of handwritten comments). In this case, when referring to an electronic comment and the image thereafter, it is difficult to identify the additionally input electronic comment as a comment corresponding to a specific handwritten portion in the image. That is, even if the user adds a comment to a handwritten portion on a paper material, since the information handwritten on the paper material is not handled as an independent object, it is not possible to manage the input electronic comment in association with the portion to which the comment is directed, that is, the information (handwritten comment) of the handwritten portion instead of the image. As a consequence, when referring to the comment, it is difficult for the user to grasp the relationship between the handwritten comment in the image and the electronic comment.

### SUMMARY OF THE INVENTION

The present invention has been made in consideration of the related art described above, and provides an information processing system, a method of controlling the information processing system, and an information processing apparatus which can accessibly display and obtain an electronic comment concerning part of the image obtained by imaging a paper medium in association with the target.

The present invention has the following arrangement. According to an aspect of the present invention, an information processing system comprises: a handwritten comment input unit configured to input handwritten comment information to a printed material obtained by printing an original image, together with coordinate information of the handwritten comment information; an electronic comment input unit configured to input electronic comment information to the handwritten comment information based on user designation; a thread management unit configured to manage handwritten comment information input by the handwritten comment input unit and electronic comment information input by the electronic comment input unit, as thread information, in association with each other; a feature pattern management unit configured to detect feature pattern information of a pattern existing near the thread information in the original image and manage the feature pattern information and the thread information in association with each other; and a thread display unit configured to perform thread display of thread information managed by the thread management unit on an image obtained by imaging the printed material, wherein the thread display of the thread information is displayed from a position of a start point of the thread information toward the pattern.

According to the present invention, it is possible to collectively and intuitively refer to information input by handwriting and information input from an information terminal. The word “intuitively” means that even if, for example, a feature pattern as a trigger for superimposition display of an electronic comment is spaced apart from a handwritten comment, the user can properly perform superimposition display of the electronic comment without making the user conscious of it.

Further features of the present invention will become apparent from the following description of exemplary embodiments with reference to the attached drawings.

### BRIEF DESCRIPTION OF THE DRAWINGS

FIG. 1 is a view showing the overall arrangement of an information processing system;

FIGS. 2A to 2D are block diagrams showing the arrangement of system constituent elements;

FIG. 3 is a view for explaining a paper material;

FIG. 4 is a flowchart concerning transmission processing for the electronic pen locus information of an electronic pen;

FIG. 5 is a flowchart concerning calculation processing for coordinates indicating the moving locus of the electronic pen of a communication terminal;

FIG. 6 is a flowchart concerning obtainment processing for handwritten comment locus information in the communication terminal;

FIG. 7 is a view for explaining a paper material;

FIG. 8 is a view for explaining an electronic bulletin board;

FIG. 9 is a flowchart concerning obtainment processing for handwritten comment information in a server;

FIG. 10 is a view for explaining the electronic bulletin board;

FIG. 11 is a flowchart concerning feature pattern registration processing in the server;

FIGS. 12A to 12C are views for explaining the electronic bulletin board;

FIG. 13 is a view for explaining the electronic bulletin board;

FIG. 14 is a flowchart concerning input processing for an electronic input form in an information terminal;

FIG. 15 is a view for explaining a search window;

FIGS. 16A to 16C are views for explaining search result windows;

FIG. 17 is a view for explaining a reference file path input window;

FIGS. 18A to 18F are views for explaining thread information;

FIGS. 19A and 19B are views for explaining feature pattern information;

FIG. 20 is a flowchart concerning thread management processing in the server;

FIG. 21 is a flowchart concerning superimposition display processing in an information terminal 300 when the information terminal superimposes and displays thread information on the image captured by an image sensing unit 306;

FIG. 22 is a flowchart concerning superimposition display processing in the server when the information terminal 300 superimposes and displays thread information on the image captured by the image sensing unit 306;

FIG. 23 is a flowchart concerning superimposition image generation processing in the information terminal;

FIGS. 24A to 24D are views for explaining thread display examples at different feature pattern positions; and

FIGS. 25A and 25B are views for explaining thread display.

### DESCRIPTION OF THE EMBODIMENTS

### First Embodiment

The embodiments for carrying out the present invention will be described below with reference to the accompanying drawings.

(System Arrangement)

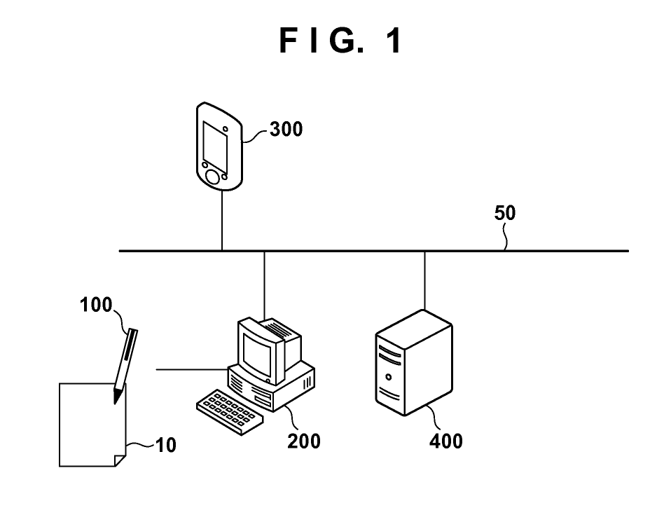

FIG. 1 is a view showing the apparatus arrangement of an information processing system according to the first embodiment of the present invention. Referring to FIG. 1, a paper material 10 on which an original image (original data) is printed may be distributed to a plurality of users or may be posted on a bulletin board. An electronic pen 100 is one-to-one connected to a communication terminal 200 by wireless communication. The communication terminal 200, a server 400, and an information terminal 300 are connected to each other via a network 50 such as a LAN. The electronic pen 100 is a device which additionally handwrites characters and graphic patterns on the paper material 10. The locus information (electronic pen locus information) of the electronic pen 100 is transmitted to the communication terminal 200.

The communication terminal 200 extracts the locus information (handwritten comment locus information) of the electronic pen 100 at the time of additional handwriting from the received electronic pen locus information and transmits the extracted information to the server 400.

The server 400 generates handwritten comment information based on the received handwritten comment locus information. The server 400 receives electronic comment information and reference file information from the information terminal 300. In this embodiment, original data, handwritten comment information, electronic comment information, and reference file information will be collectively referred to as electronic bulletin board information and stored and managed in the server 400.

The information terminal 300 displays the electronic bulletin board information managed by the server 400 on the display unit. The information terminal 300 transmits, to the server 400, electronic comment information and reference file information input by the user to the electronic bulletin board information displayed on the display unit. The information terminal 300 includes an image sensing unit such as a camera. This image sensing unit images the paper material 10 and displays the captured image of the paper material 10 on the display unit. At this time, the information terminal 300 can superimpose and display the electronic bulletin board information on the captured image displayed on the display unit. If the information terminal 300 includes no image sensing unit, the terminal may use an image sensing unit such as a camera externally connected via a USB (Universal Serial Bus) cable or the like.

(Electronic Pen)

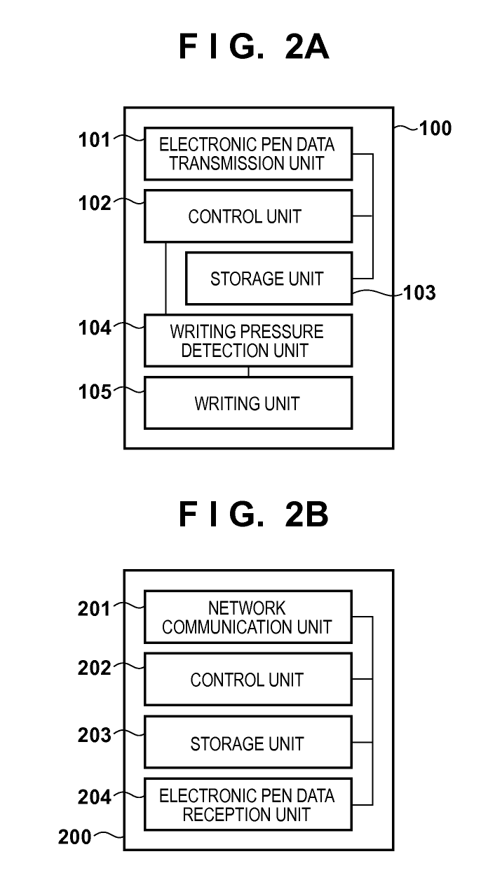

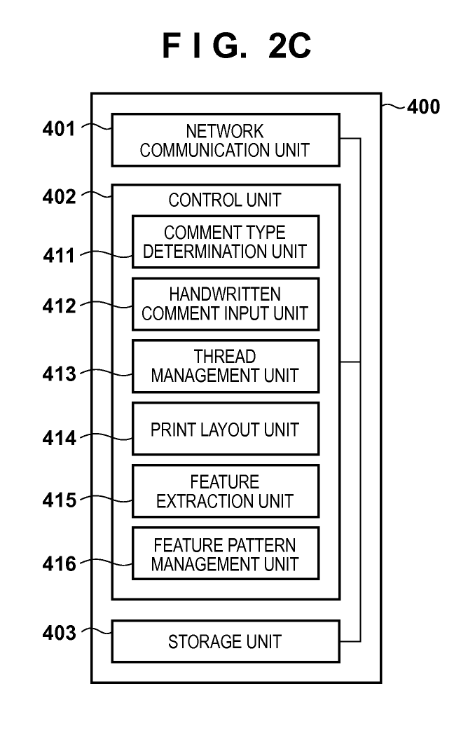

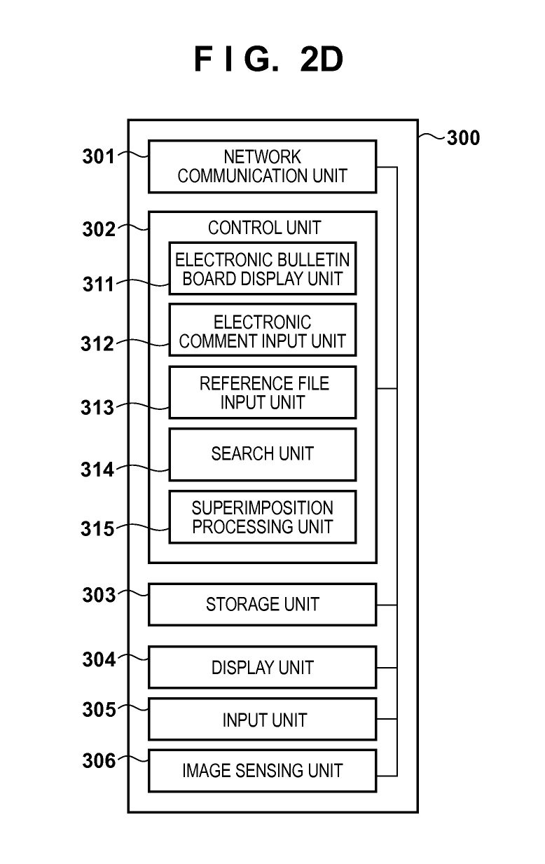

FIG. 2A explains the arrangement of the electronic pen 100 in this embodiment. A writing unit 105 is implemented by a pen, with which the user writes characters and graphic patterns on the paper material 10 in a visible state by using ink in an ink cartridge. A writing pressure detection unit 104 is implemented by a writing pressure sensor, which detects the writing pressure applied to the pen when the user writes on the paper material 10. An electronic pen data transmission unit 101 is implemented by an infrared transmitter which transmits infrared light and an ultrasonic transmitter which transmits ultrasonic waves. This unit 101 transmits electronic pen locus information to the communication terminal 200. A storage unit 103 is implemented by a memory such as a RAM or ROM, which stores temporary data required by a control unit 102. The control unit 102 comprehensively controls the electronic pen 100 and is implemented by causing a CPU to execute program codes stored in the storage unit 103. The control unit 102 performs control to transmit a pressurization start signal indicating the start of pressurization to the electronic pen data transmission unit 101 by infrared transmission when the writing pressure detection unit 104 detects the start of pressurization. In addition, the control unit 102 performs control to transmit a pressurization end signal indicating the end of pressurization to the electronic pen data transmission unit 101 by infrared transmission when the writing pressure detection unit 104 detects the end of pressurization. Furthermore, the control unit 102 controls the electronic pen data transmission unit 101 to transmit ultrasonic waves in a predetermined cycle within the time from the start of pressurization to the end of pressurization. The ultrasonic signal transmitted from the electronic pen data transmission unit 101 is a signal representing the position information of the electronic pen, as will be described later.

(Communication Terminal)

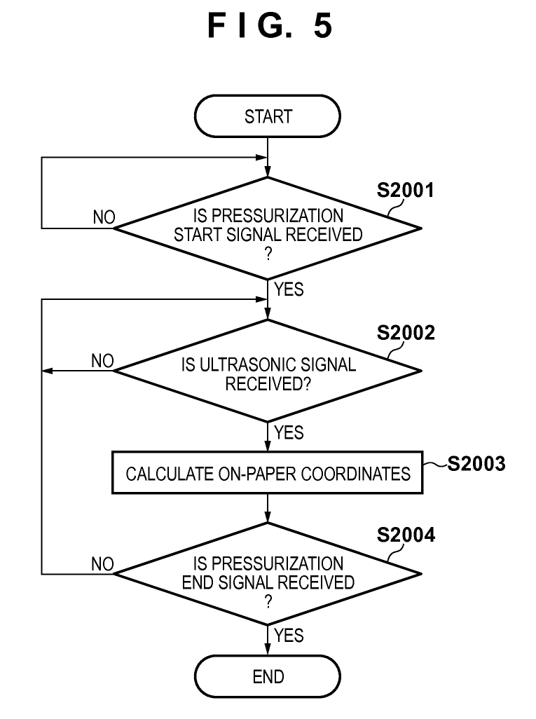

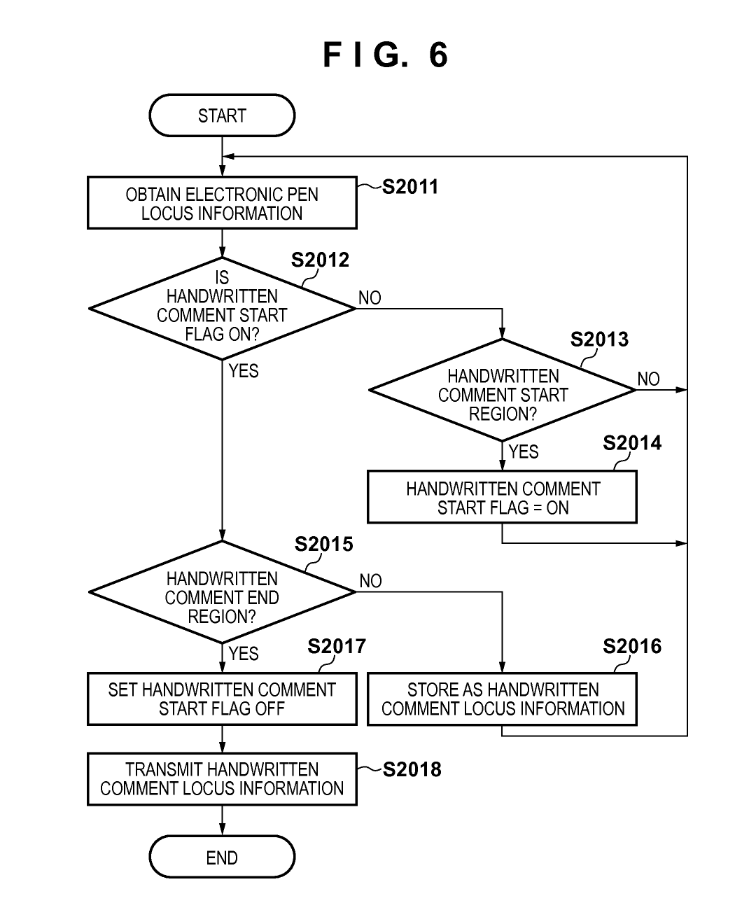

FIG. 2B explains the arrangement of the communication terminal 200 in this embodiment. An electronic pen data reception unit 204 is implemented by a receiver including one infrared reception sensor and two ultrasonic reception sensors. The electronic pen data reception unit 204 receives the electronic pen locus information constituted by the infrared signal and ultrasonic signal transmitted from the electronic pen data transmission unit 101 of the electronic pen 100. A network communication unit 201 is implemented by a LAN I/F and transmits handwritten comment locus information to the server 400 via the network 50. A storage unit 203 is implemented by a memory such as a ROM, RAM, or HDD, which stores temporary data, electronic pen locus information, handwritten comment locus information, and the like used by a control unit 202. The control unit 202 comprehensively controls the respective units and is implemented by causing the CPU to execute program codes stored in the storage unit 203. The control unit 202 performs control to store the electronic pen locus information received by the electronic pen data reception unit 204 in the storage unit 203. The control unit 202 controls the network communication unit 201 to extract handwritten comment locus information from the electronic pen locus information read out from the storage unit 203 and transmit the extracted information to the server 400. The control unit 202 executes a procedure (FIG. 5) for receiving locus information from the electronic pen and calculating on-paper coordinates in accordance with the writing operation of the electronic pen by the user or a procedure (FIG. 6) for extracting a series of handwriting as handwritten comment locus information.

(Server)

FIG. 2C explains the arrangement of the server 400. A network communication unit 401 is implemented by a LAN I/F, which transmits and receives various types of data between the communication terminal 200 and the information terminal 300 via the network 50. A storage unit 403 is implemented by a memory such as a RAM, ROM, or HDD, which stores electronic bulletin board information in this embodiment. The network communication unit 401 also receives comment information and stores it in the storage unit 403. The electronic bulletin board information includes original data of the same content as that of the image printed on a paper surface, thread information, and temporary data.

A control unit 402 comprehensively controls the respective units and is implemented by causing the CPU to execute program codes stored in the storage unit 403.

The control unit 402 further includes a comment type determination unit 411, a handwritten comment input unit 412, a thread management unit 413, a print layout unit 414, a feature extraction unit 415, and a feature pattern management unit 416.

The comment type determination unit 411 determines whether the comment information received from the network communication unit 401 belongs to one of these respective types: handwritten comment information, electronic comment information, and reference file information. In this embodiment, the server 400 and the information terminal 300 communicate by HTTP protocol and so do the server 400 and the communication terminal 200. When transmitting and receiving comment information, they also transmit and receive the identifier (comment identifier) of a comment type. The comment type determination unit 411 determines the comment type of received comment information by referring to the identifier of the comment type.

If the comment type determination unit 411 determines that the received comment information belongs to the comment type of handwritten comment information, the received comment information is handwritten comment locus information. For this reason, the handwritten comment input unit 412 bitmaps the handwritten comment locus information to generate handwritten comment information, and stores the handwritten comment information in the storage unit 403. The thread management unit 413 manages the generated handwritten comment information.

If the comment type determination unit 411 determines that the received comment information belongs to the comment type of electronic comment information or reference file information, the received comment information is electronic comment information or reference file information. The thread management unit 413 manages these pieces of electronic comment information or reference file information.

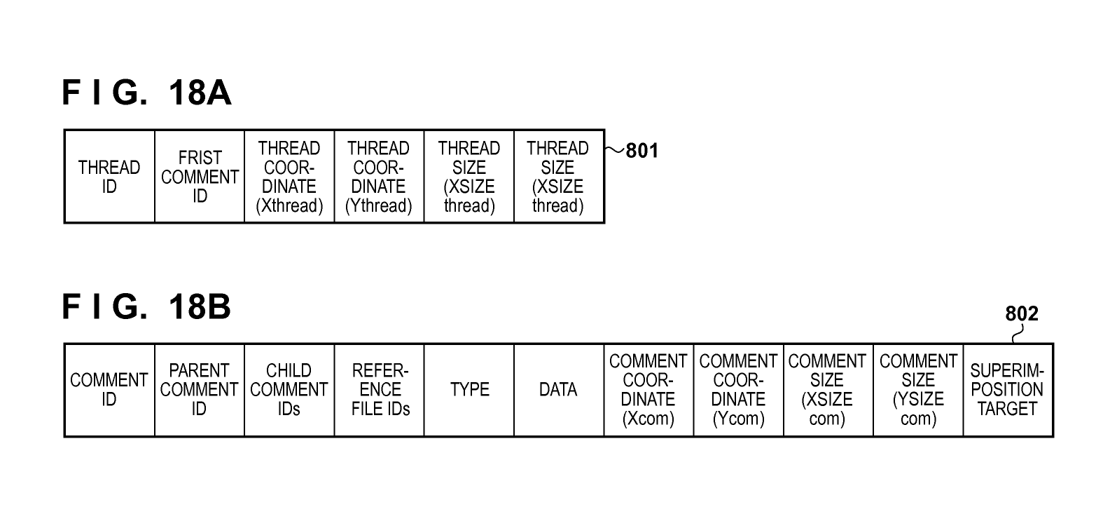

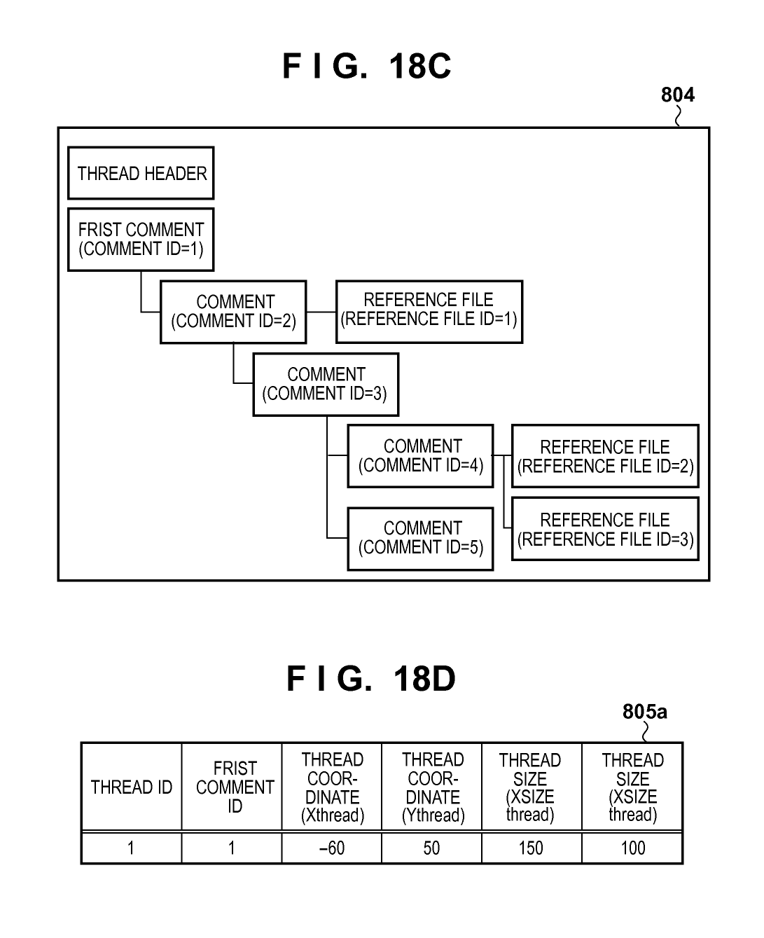

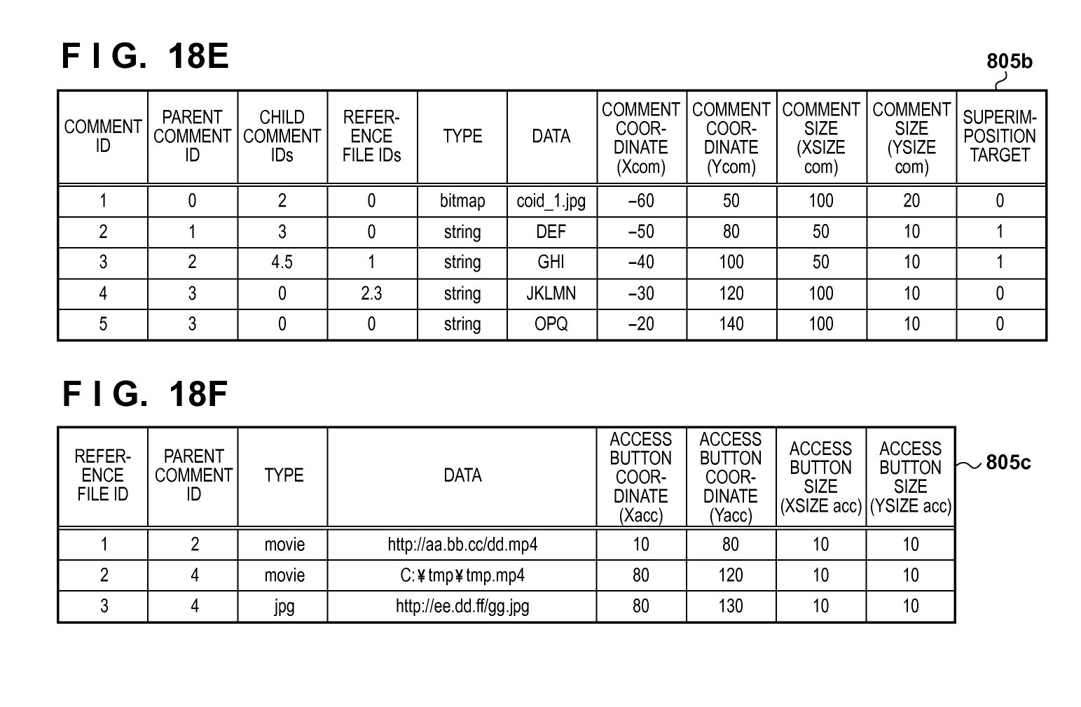

The thread management unit 413 generates thread information associated with each of handwritten comment information, electronic comment information, and reference file information and stores the thread information in the storage unit 403. As will be described later with reference to FIGS. 18A to 18F, this thread information is a data table indicating the parent-child relationship between the respective pieces of information including handwritten comment information, electronic comment information, and reference file information and the positional relationship between them when they are input. The thread management unit 413 updates thread information in accordance with the addition of handwritten comment information, electronic comment information, or reference file information.

Upon receiving a print request for electronic bulletin board information from the information terminal 300, the print layout unit 414 generates print data having the print layout of the electronic bulletin board information. In this embodiment, the print layout unit 414 handles, as a print target, the electronic bulletin board display result obtained by superimposing and displaying thread information stored in the storage unit 403 on original data 700 (to be described later). Printing is implemented by issuing a print instruction to a printer (not shown) connected to the information terminal 300 by using the printer driver installed in the information terminal 300. That is, the information terminal 300 includes a print instruction unit which issues a print instruction for electronic bulletin board information and prints the electronic bulletin board information.

The feature extraction unit 415 extracts a feature pattern such as a text pattern or graphic pattern from the original data 700. This embodiment uses a known feature point detection technique and feature amount extraction technique for feature pattern extraction. For example, the feature extraction unit 415 detects feature points from an image around a designated comment. If the number of feature points is larger than a predetermined threshold, the feature extraction unit 415 extracts a rectangular region including these feature points as a feature pattern. At the same time, the feature extraction unit 415 calculates a feature amount. The position of this feature pattern is defined as the coordinates of the upper left end of the rectangular region including the feature amounts. Note that a feature pattern detection method to be used is not limited to the above method, and other methods may be used.

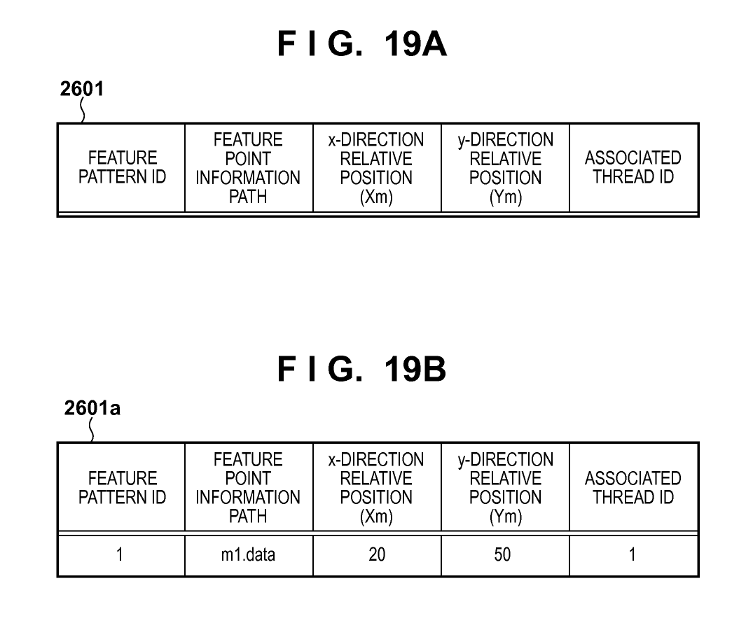

The feature pattern management unit 416 generates a feature pattern information table and stores it in the storage unit 403. The feature pattern information table is a data table which holds a list of feature pattern information representing information for identifying the position of the feature pattern and the feature points themselves, as will be described with reference to FIGS. 19A and 19B. The feature pattern management unit 416 updates the feature pattern information table every time a new thread is added.

(Information Terminal)

FIG. 2D explains the arrangement of the information terminal 300. A network communication unit 301 is implemented by a LAN I/F, which transmits and receives various types of data to and from the server 400 via the network 50. A storage unit 303 is implemented by a memory such as a RAM, ROM, or HDD, which stores temporary data used by a control unit 302 in this embodiment.

A display unit 304 is implemented by a display device typified by a display (including a touch panel), which displays electronic bulletin board information, the image captured by the image sensing unit 306, and the like. An input unit 305 is implemented by an input device typified by a touch panel, a mouse, a keyboard, and the like, which accepts input operation from the user. An image sensing unit 306 is implemented by an image sensor typified by a camera or the like, which obtains a captured image of a paper material.

The control unit 302 comprehensively controls the respective units and is implemented by causing the CPU to execute program codes stored in the storage unit 303.

The control unit 302 further includes an electronic bulletin board display unit 311, an electronic comment input unit 312, a reference file input unit 313, a search unit 314, and a superimposition processing unit 315.

The electronic bulletin board display unit 311 displays the electronic bulletin board information obtained from the server 400 on the display unit 304. The electronic bulletin board display unit 311 displays an electronic input form for the acceptance of the input of an electronic comment from the user.

The electronic comment input unit 312 obtains the character string (electronic comment) input to the electronic input form by the user using the input unit 305, and transmits the obtained information as electronic comment information to the server 400. The reference file input unit 313 obtains a path to the reference file (reference file path) input to the electronic input form by the user using the input unit 305, and transmits the obtained information as reference file information to the server 400. The search unit 314 performs search processing based on the search key input to the electron input form by the user using the input unit 305.

The superimposition processing unit 315 displays the image of the paper material imaged by the image sensing unit 306 on the display unit 304 and also superimposes and displays electronic bulletin board information on the image of the paper material.

(Handwritten Comment Input)

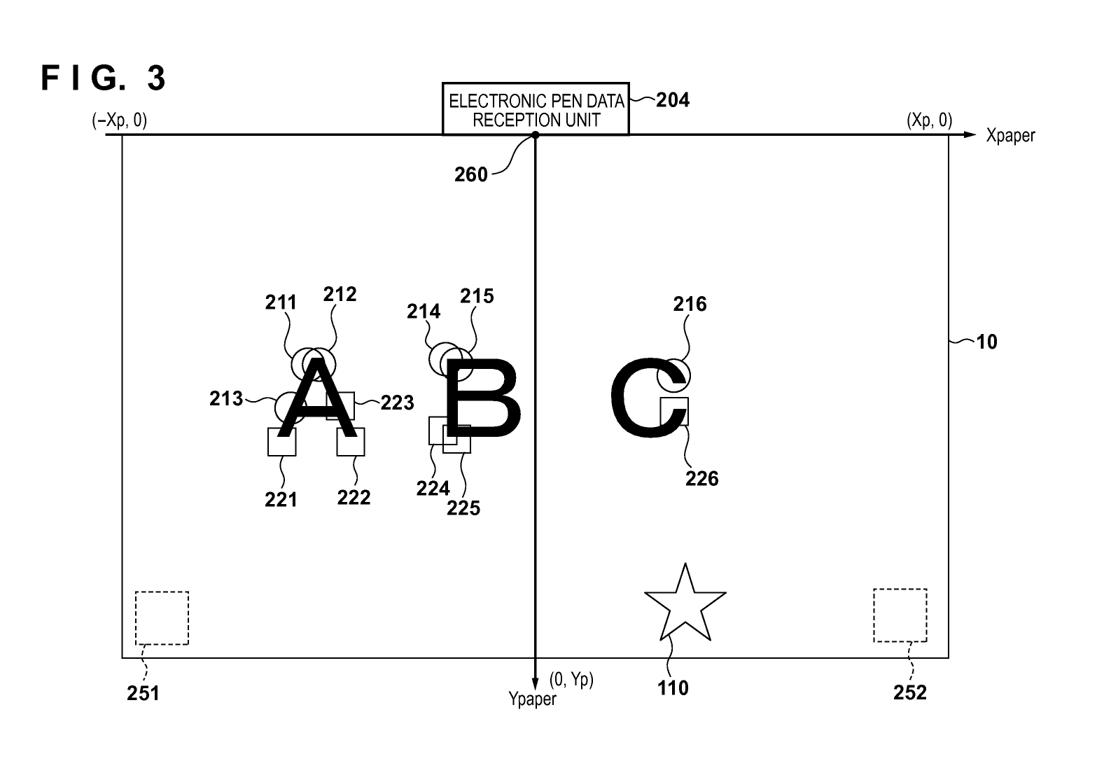

FIG. 3 explains the paper surface of the paper material 10 in this embodiment. An object 110 is printed as the content of original data on the paper material 10.

In this embodiment, the coordinate system on the paper surface is expressed by (Xpaper, Ypaper). A receiver which implements the electronic pen data reception unit 204 is placed in the middle of the upper portion of the paper material 10, and a paper surface origin 260 is set to (0, 0) to match with an electronic bulletin board whose coordinate origin is set to the middle of the upper portion of the original data 700 (to be described later). The paper material 10 is a rectangle whose vertices are set to positions (−Xp, 0), (Xp, 0), (−Xp, Yp), and (Xp, Yp) in the coordinate system on the paper surface. For this reason, when inputting a handwritten comment, the user places a paper material on a flat surface such as a plate, and places the receiver in the middle of the upper portion of the flat surface.

When starting to handwrite a comment on the paper material 10 with the electronic pen 100, the user checks a handwritten comment start region 251. The user writes “ABC” as a handwritten comment.

Points 211 to 216 correspond to pressurization start points on “ABC” which are detected by the writing pressure detection unit 104. Positions 221 to 226 correspond to pressurization end points on “ABC” which are detected by the writing pressure detection unit 104.

Assume that the user checks a handwritten comment end region 252 after the completion of handwriting of a comment.

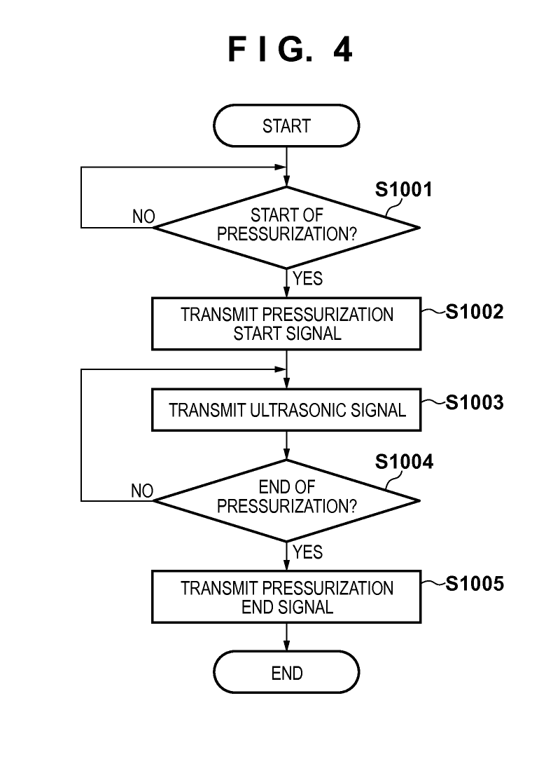

FIG. 4 explains a procedure in which the electronic pen 100 transmits a series of electronic pen locus information to the communication terminal 200.

In step S1001, the control unit 102 of the electronic pen 100 determines whether the writing pressure detection unit 104 has detected the start of pressurization. If the control unit 102 has detected the start of pressurization, the process advances to step S1002. The control unit 102 performs control to transmit a pressurization start signal from the electronic pen data transmission unit 101 by infrared light. The control unit 102 then transmits an ultrasonic signal in step S1003. In step S1004, the control unit 102 keeps transmitting ultrasonic signals in a predetermined cycle until the writing pressure detection unit 104 detects the end of pressurization. Upon detecting the end of pressurization, the control unit 102 performs control to transmit a pressurization end signal from the electronic pen data transmission unit 101 by infrared in step S1005. Ultrasonic signals transmitted from the instant a pressurization start signal is transmitted to the instant a pressurization end signal is transmitted are a series of electronic pen locus information.

FIG. 5 explains a procedure in which the communication terminal 200 receives a series of electronic pen locus information from the electronic pen 100 and calculates the coordinates (on-paper coordinates) indicating the moving locus of the electronic pen.

In step S2001, the control unit 202 determines whether the electronic pen data reception unit 204 has received a pressurization start signal by infrared light. If the electronic pen data reception unit 204 has received a pressurization start signal, the process advances to step S2002.

In step S2002, the control unit 202 determines whether the electronic pen data reception unit 204 has received an ultrasonic signal. If the control unit 202 determines that no ultrasonic signal has been received, the process advances to step S2004.

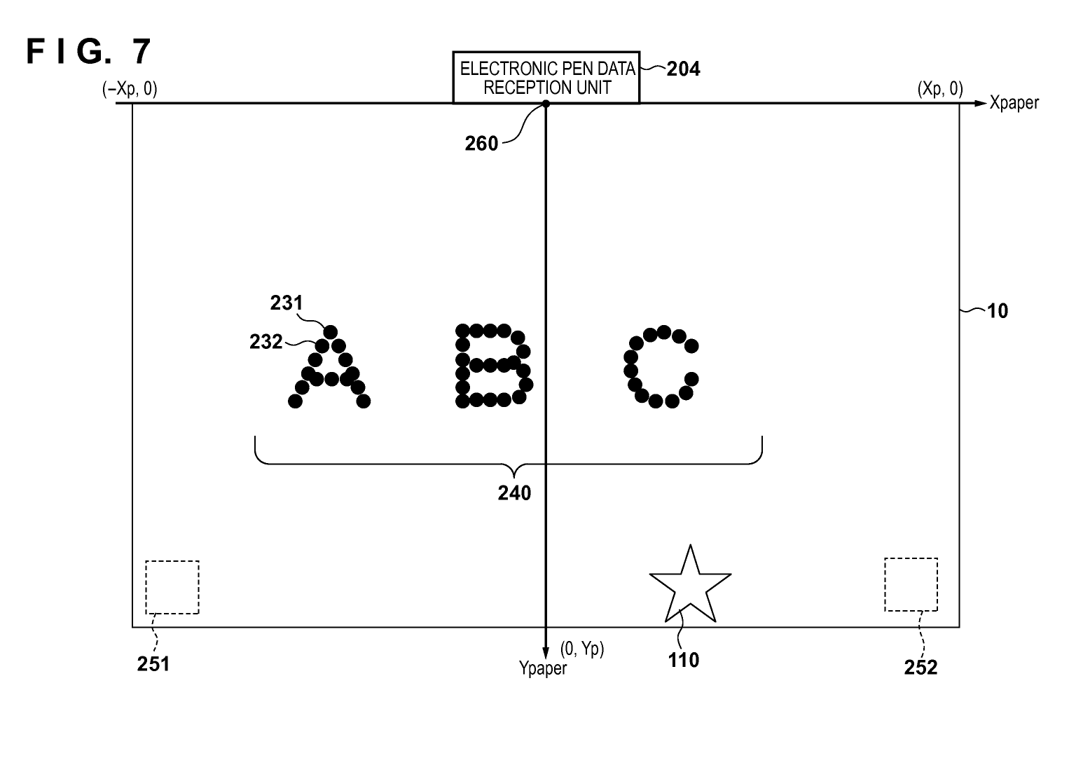

Upon determining that an ultrasonic signal has been received, the control unit 202 calculates the on-paper coordinates of the electronic pen from the difference in reception time between the ultrasonic signals received by two ultrasonic reception sensors and the distance between the two ultrasonic sensors in step S2003. Note that on-paper coordinates will be described later with reference to FIG. 7.

In step S2004, the control unit 202 then determines whether the electronic pen data reception unit 204 has received an infrared pressurization end signal. If the control unit 202 determines that no pressurization end signal has been received, the process returns to step S2002. Upon determining that no pressurization end signal has been received, the control unit 202 terminates the obtainment of a series of pen locus information from the start of pressurization to the end of pressurization. That is, the control unit 202 sequentially calculates the information of on-paper coordinates indicating the moving locus of the electronic pen from continuously received electronic pen locus information by executing the processing procedure shown in FIG. 5. Note that this information including the information of on-paper coordinates indicating the moving locus of the electronic pen which is calculated in step S2003 will be referred to as electronic pen locus information hereinafter.

FIG. 6 explains a procedure in which the communication terminal 200 handles the handwritten comment “ABC” in FIG. 3 as one piece of handwritten comment locus information. That is, the control unit 202 executes the processing procedure in FIG. 6 to extract handwritten comment locus information from a series of electronic pen locus information.

In step S2011, the control unit 202 obtains electronic pen locus information including the information of the on-paper coordinates of the electronic pen calculated in the processing procedure in FIG. 5.

In step S2012, the control unit 202 determines whether the handwritten comment start flag is ON. The handwritten comment start flag is stored in the storage unit 203. The initial value of this flag is set to OFF.

Upon determining in step S2012 that the handwritten comment start flag is OFF, the control unit 202 determines in step S2013 whether the on-paper coordinates of the electronic pen indicated by the pen locus information fall within the handwritten comment start region 251. If the on-paper coordinates of the electronic pen do not fall within the handwritten comment start region 251, the process returns to step S2011. If the on-paper coordinates of the electronic pen fall within the handwritten comment start region 251, the control unit 202 sets the handwritten comment start flag ON in step S2014, the process returns to step S2011.

Upon determining in step S2012 that the handwritten comment start flag is ON, the control unit 202 determines in step S2015 whether the on-paper coordinates of the electronic pen indicated by electronic pen locus information fall within the handwritten comment end region 252. If the on-paper coordinates do not fall within the handwritten comment end region 252, the control unit 202 stores the electronic pen locus information as part of the handwritten comment locus information in the storage unit 203 in step S2016. The process returns to step S2011. If the on-paper coordinates of the electronic pen fall within the handwritten comment end region 252, the control unit 202 sets the handwritten comment start flag OFF in step S2017. In step S2018, the control unit 202 transmits, to the server 400, the series of electronic pen locus information from the start of the handwritten comment to the end of the handwritten comment, which are stored in the storage unit 203 in step S2016, as one piece of handwritten comment locus information (for example, “ABC”). In addition, when transmitting this information, the control unit 202 includes, in the handwritten comment locus information, a handwritten comment identifier indicating that the handwritten comment locus information is of a type belonging to handwritten comment information.

FIG. 7 is a view for explaining handwritten comment locus information as the on-paper coordinate calculation result described with reference to FIG. 3. For example, the coordinates of positions 231 and 232 are examples of the coordinates obtained as a result of on-paper coordinate calculation. A series of electronic pen locus information 240 obtained as a result of sequentially performing on-paper coordinate calculation with respect to the pressurization start points 211 to 216 and the pressurization end points 221 to 226 respectively corresponding to the start points are the handwritten comment locus information “ABC”.

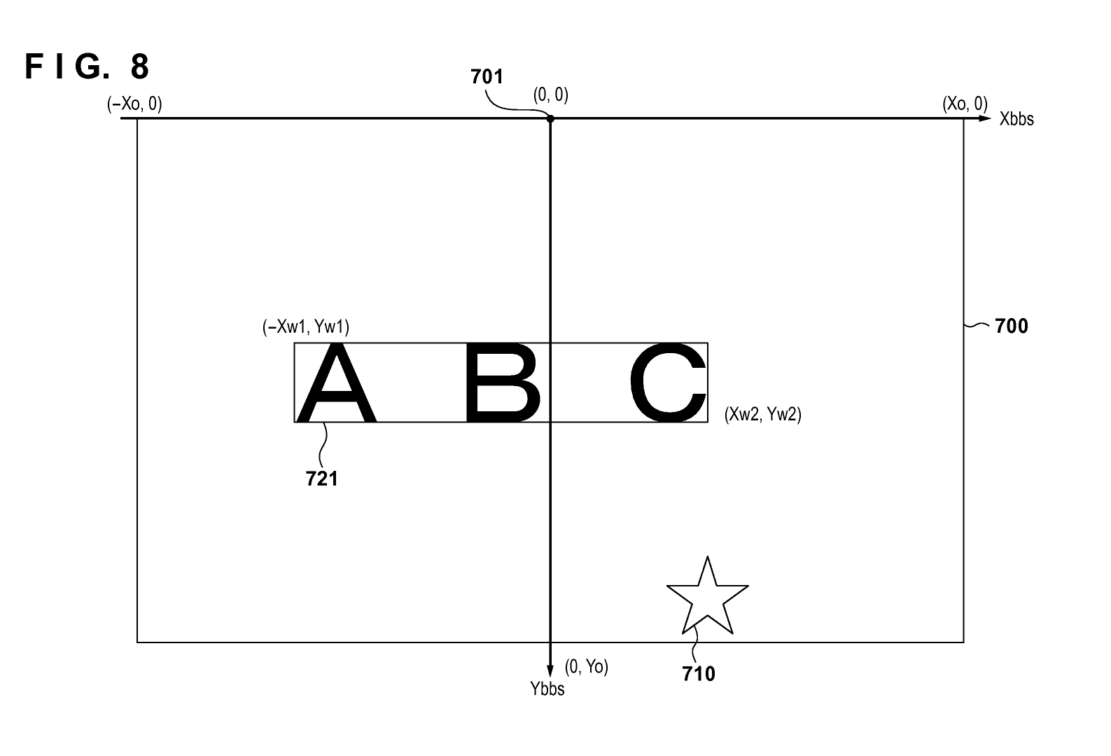

FIG. 8 explains the original data 700 corresponding to the paper material 10 in this embodiment. The storage unit 403 stores the original data 700. Note that in this embodiment, the original data 700 is the original data of the image printed on the paper material 10. Print processing is applied to the original data 700, and the resultant data is printed on the paper material 10. An object 710 is an object included in the original data 700. In this case, a handwritten comment 721 is not included in the original data 700. If, however, original data is obtained by imaging an original on which a handwritten comment is written, the original data includes a handwritten comment pattern.

In this embodiment, the coordinate system on the electronic bulletin board is expressed by (Xbbs, Ybbs), and a middle point on the upper portion of the original data 700 is expressed as an electronic bulletin board origin 701 (0,0). The electronic bulletin board origin 701 of the original data 700 corresponds to the paper surface origin 260 on the paper material 10. The original data 700 is expressed by four points, namely (−Xo, 0), (Xo, 0), (−Xo, Yo), and (Xo, Yo), in the electronic bulletin board coordinate system.

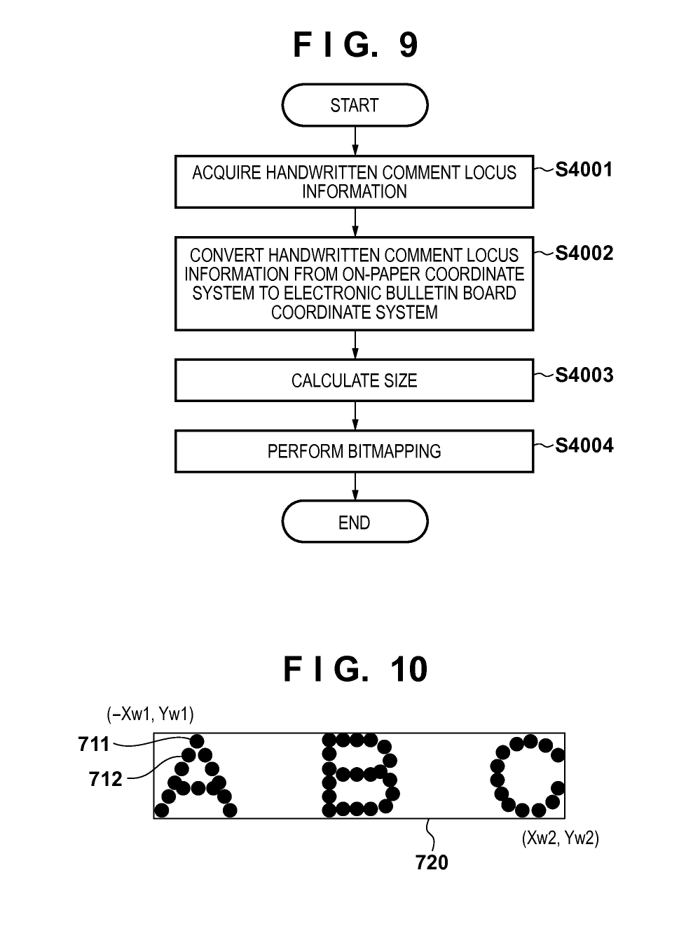

FIG. 9 explains a procedure in which the handwritten comment input unit 412 of the server 400 obtains handwritten comment information by bitmapping handwritten comment locus information. The procedure in FIG. 9 will be described by taking the handwritten comment locus information 240 “ABC” in FIG. 3 as an example.

The storage unit 403 stores the original data 700.

In step S4001, the handwritten comment input unit 412 receives the handwritten comment locus information 240 and handwritten comment identifier transmitted from the communication terminal 200 in step S2018. The handwritten comment locus information 240 includes the coordinate information of the handwritten comment expressed by the on-paper coordinates (Xpaper, Ypaper).

In step S4002, the handwritten comment input unit 412 converts the coordinate information of the handwritten comment expressed by the on-paper coordinates included in the handwritten comment locus information 240 into information in the coordinate system (Xbbs, Ybbs) on the electronic bulletin board. Conversion processing is implemented by determining conversion coefficients in advance based on the size of the paper material 10 and the size of the original data 700.

FIG. 10 shows an example of the result obtained by converting the handwritten comment locus information 240 into information in the coordinate system (Xbbs, Ybbs) on the electronic bulletin board. This operation obtains coordinates typified by coordinates 711 and 712.

In step S4003, the handwritten comment input unit 412 calculates the size of a minimum rectangle 720 incorporating the coordinates of the coordinate-converted handwritten comment locus information, thereby obtaining upper left coordinates (−Xw1, Yw1) of the minimum rectangle and lower right coordinates (Xw2, Yw2) of the minimum rectangle.

In step S4004, the handwritten comment input unit 412 colors the image data at the coordinates of the coordinate-converted handwritten comment locus information and draws the resultant data as a bitmap. The handwritten comment input unit 412 then generates a bitmap 721 of the rectangle 720 by bitmapping the handwritten comment, and stores the bitmap in the storage unit 403. The handwritten comment input unit 412 transmits a file path to the bitmap 721 stored in the storage unit 403, upper left coordinates (−Xw1, Yw1) of the bitmap, and the handwritten comment identifier received in step S4001, as handwritten comment information, to the thread management unit 413.

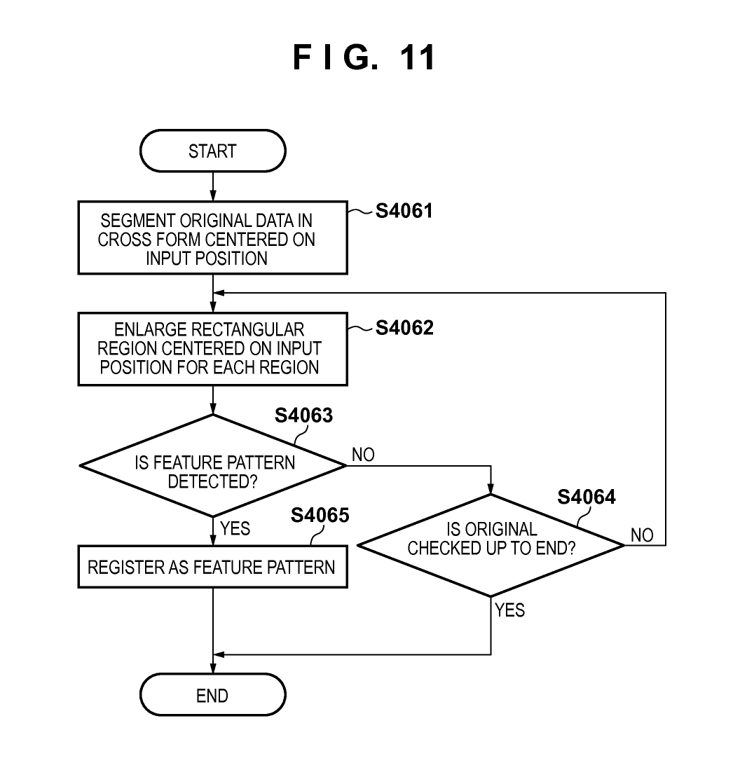

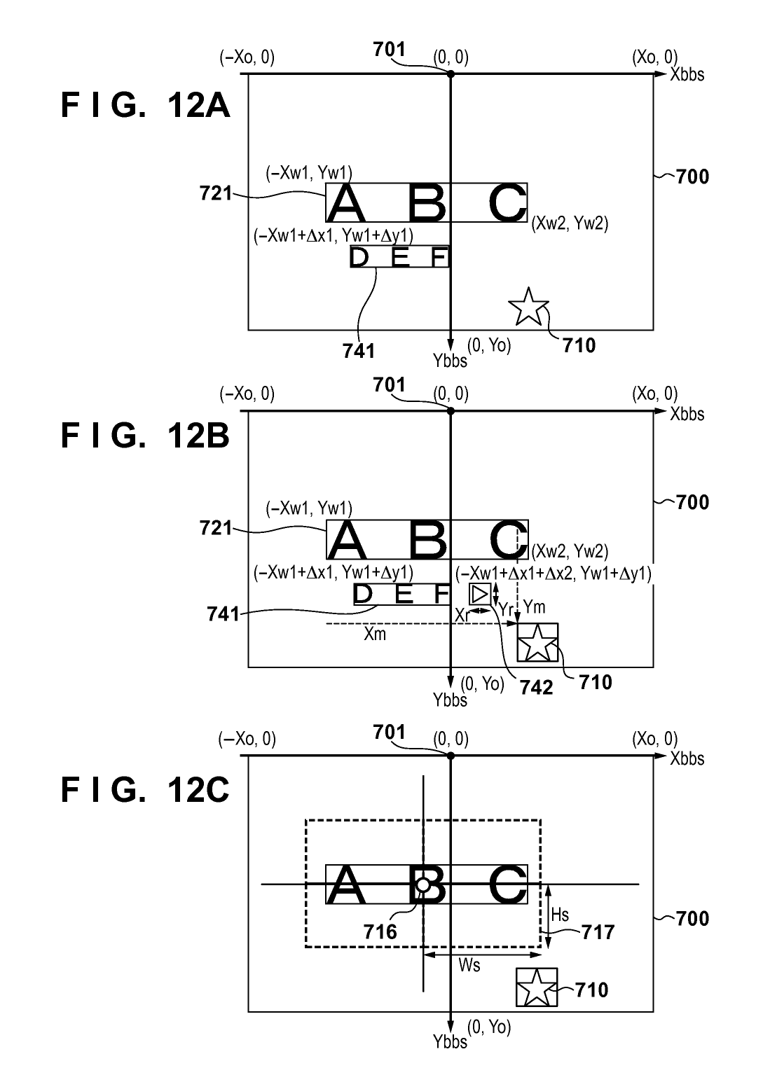

FIG. 11 shows a procedure for detecting and registering a feature pattern existing in a region near a comment. For example, executing this procedure will detect a feature pattern 710 in a lower right region relative to the comment data 721 (“ABC”) as the first comment when the comment data 721 and the object 710 have a positional relationship like that shown in FIG. 12B. The feature pattern management unit 416 of the server 400 executes this processing in the thread management processing in FIG. 20 (to be described later) when a new thread is added (step S4021). In addition, at this time, the thread information of the newly added thread is provided. Note that comment data 741 is an electronic comment, which is not a feature extraction target in this embodiment.

In step S4061, the feature pattern management unit segments the original data in a cross shape, centered on an origin 716, with origin being the central position of the first comment of the designated thread, as shown in FIG. 12C. Subsequently, each segmented region, that is, a rectangular region 717 having the origin 716 as one vertex and a size defined by a search range (Ws, Hs) is defined as a search region. (Ws, Hs) are variables. The initial values of the variables are (0, 0).

In step S4062, the feature pattern management unit enlarges the rectangular region 717 by increasing each of search distances Ws and Hs by a predetermined size. This unit performs the same processing for the four search regions.

In step S4063, the feature pattern management unit transfers the image in each search region to the feature extraction unit 415 and determines whether each region includes the feature pattern.

If the feature pattern management unit detects no feature pattern in step S4063, the unit detects in step S4064 whether it has checked the original to its end. If YES in step S4064, the feature pattern management unit terminates the processing. If NO in step S4064, the process shifts to step S4062. Note that since the repeat count of this process until the search reaches an end of each region may vary, the feature pattern management unit may continue the search only in a region where the search has not reached the end of the origin.

Upon detecting a feature pattern in step S4063, the feature pattern management unit additionally writes the information of the feature pattern as feature pattern information (to be described later) in the feature pattern information table in step S4065. The x-direction relative positions of feature pattern information 2601 in FIGS. 19A and 19B are relative positions (Xm) from comment coordinate (Xcom) of the first comment to the x-coordinate of the feature pattern. The same applies to the y-direction relative positions of the feature pattern information 2601. In addition, the value of an associated thread ID is the thread ID of a new thread included in thread information provided as an input. Comment coordinates of the first comment may be set to a fixed position in advance. Referring to FIG. 12B, for example, the comment coordinates are defined by the upper left corner of the minimum rectangular region which is parallel to the coordinate system and includes the comment.

(Electronic Input Form)

FIG. 13 explains an electronic input form. FIG. 13 shows an example of the electronic bulletin board information which is stored in the storage unit 403 of the server 400, received by the information terminal 300 from the server 400, and displayed by the electronic bulletin board display unit 311. The displayed information has the handwritten comment 721 superimposed and displayed on the original data based on the locus information of the comment.

In this case, when the user selects and designates, via the input unit 305, coordinates in the region where the electronic bulletin board information displayed on the display unit 304 is displayed, the electronic bulletin board display unit 311 displays an electronic input form 730. FIG. 13 shows that coordinates in the region of the handwritten comment (bitmap) 721 are selected and designated. In this case, the electronic bulletin board display unit 311 displays the electronic input form 730 at an offset position (−Xw1+Δx1, Yw1+Δy1) offset from coordinates of the handwritten comment 721 by (Δx1, Δy1). When the user selects and designates coordinates outside the region of the handwritten comment 721 via the input unit 305, the electronic bulletin board display unit 311 displays the electronic input form 730 at a position corresponding to the selected and designated coordinates.

The electronic input form 730 includes a character string input region (character string input portion) 731, an electronic comment addition button 732, a keyword search button 733, an image search button 734, a moving image search button 735, and a reference file attachment button (attachment portion) 736.

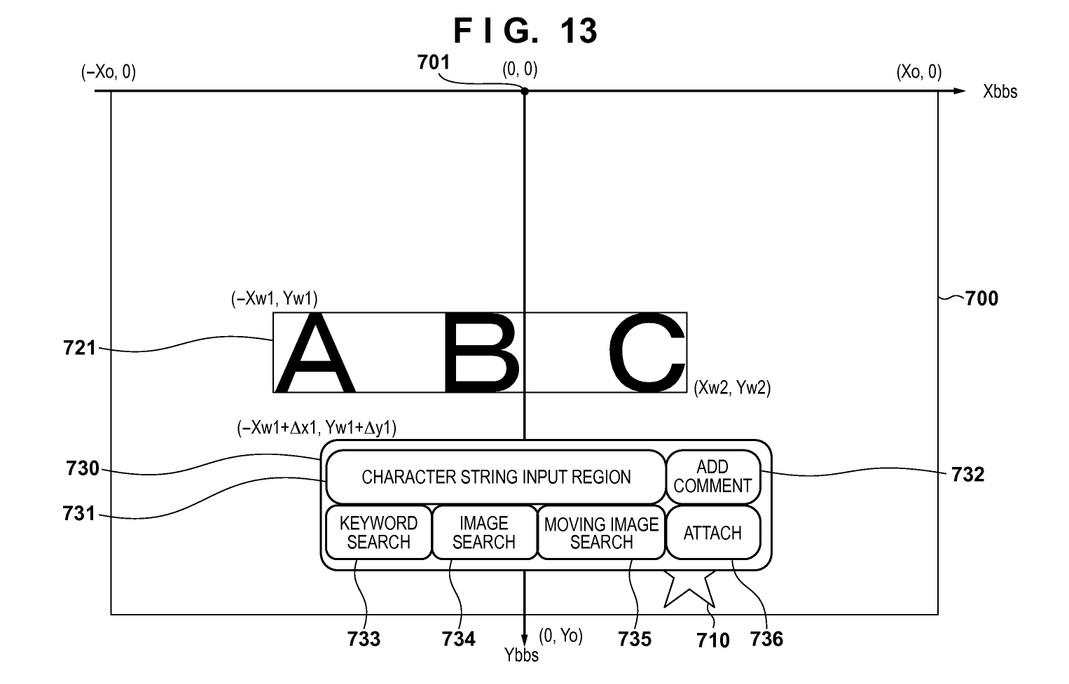

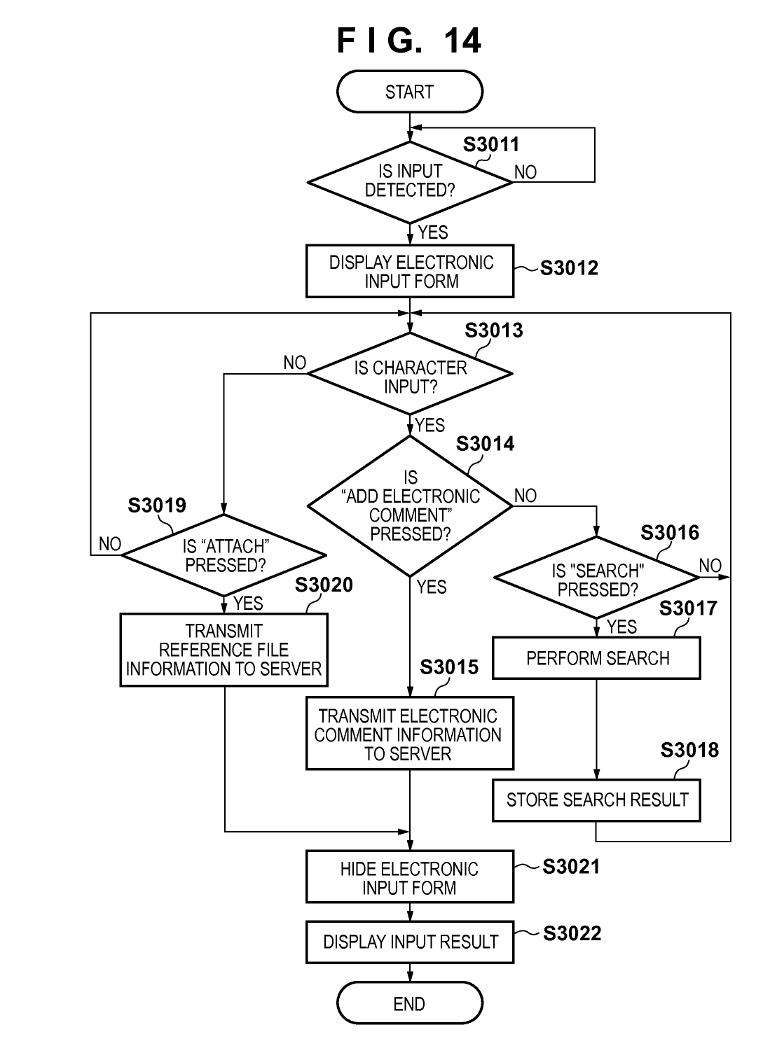

FIG. 14 explains a procedure for inputting the electronic input form 730. In step S3011, if the electronic bulletin board display unit 311 detects an input start event by detecting whether the user has selected and designated coordinates of the region displayed on the display unit 304 via the input unit 305, the electronic bulletin board display unit 311 determines whether the selected and designated coordinates fall within the region of the electronic bulletin board. In step S3012, the electronic bulletin board display unit 311 displays the electronic input form 730 at the offset position upon determining that coordinates in the region of the electronic bulletin board information are selected and designated. Upon determining that coordinates outside the region of the electronic bulletin board information are selected and designated, the electronic bulletin board display unit 311 displays the electronic input form 730 at a position corresponding to the selected and designated coordinates. The electronic comment input unit 312 stores, in the storage unit 303, the coordinates of the position at which the electronic input form 730 is displayed.

In step S3013, the electronic comment input unit 312 determines whether the user has input characters to the character string input region 731 via the input unit 305. Upon determining that the user has input characters, the electronic comment input unit 312 stores the input character string in the storage unit 303.

In step S3014, the electronic comment input unit 312 determines whether the user has pressed the electronic comment addition button 732. Upon determining in step S3014 that the user has pressed the electronic comment addition button 732, the electronic comment input unit 312 transmits in step S3015, to the server 400, the coordinates of the electronic input form 730 stored in the storage unit 303 and the character string input to the character string input region 731 as electronic comment information. When transmitting this electronic comment information, the electronic comment input unit 312 includes an electronic comment identifier indicating that the transmitted comment information is the information of a type belonging to electronic comment information.

Upon determining that in step S3014 that the user has not pressed the electronic comment addition button 732, the electronic comment input unit 312 determines in step S3016 whether the user has pressed the keyword search button 733, the image search button 734, or the moving image search button 735.

If the electronic comment input unit 312 determines that the user has pressed any one of the search buttons, the search unit 314 searches, in step S3017, for the character string input to the character string input region 731 by using the Web search engine assigned to the corresponding search type. Since a known search technique is used to search for this character string, a detailed description of the technique will be omitted.

At this time, the electronic bulletin board display unit 311 displays, on the input unit 305, the input character string search result obtained by using the search engine selected by the user by button selection. In this case, in step S3018, the search unit 314 stores the search processing result obtained in step S3017 in the storage unit 303. The electronic bulletin board display unit 311 can hide a search engine window when the user presses a hide button on the search engine window.

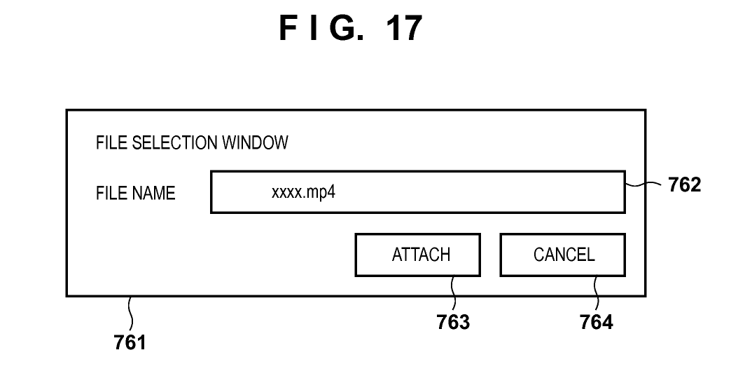

Upon determining in step S3013 that the user has input characters to the character string input region 731, the electronic bulletin board display unit 311 determines in step S3019 whether the user has pressed the reference file attachment button 736. Upon determining that the user has pressed the reference file attachment button 736, the electronic bulletin board display unit 311 displays the reference file path input window (see FIG. 17) in step S3020. The reference file input unit 313 stores, in the storage unit 303, the reference file path input on the reference file path input window. The reference file includes an image file, a moving image file, a document file, a voice file, and an electronic file typified by a search result or the like stored in the search unit 314.

The reference file input unit 313 also calculates the coordinates of the position at which a reference file access button for referring to a reference file (the coordinates of the reference file access button) should be displayed based on the coordinates of the position at which the electron input form is displayed. The coordinates concretely calculated in this embodiment are the coordinates of the position obtained by shifting the coordinates of the electronic input form by (Δx2, 0).

The reference file input unit 313 then transmits the reference file path and the information of the coordinates of the reference file access button as reference file information to the server 400. When transmitting this reference file information, the reference file input unit 313 includes a reference file identifier indicating that the transmitted file information is the information of a type belonging to reference file information. The description so far is about the processing in step S3020. Note that the reference file access button is an image object selected by user designation for reference to the reference file.

In step S3021, upon detecting that an input end event, that is, pressing of the electronic comment addition button, attachment button, or search button, the electronic bulletin board display unit 311 hides the electronic input form 730.

In step S3022, the electronic bulletin board display unit 311 displays the input result at the coordinates at which the electronic input form 730 is displayed. Assume that the handwritten comment 721 is selected by user designation and the electronic input form 730 is displayed. In this case, if the content input to the electronic input form is an electronic comment, the electronic bulletin board display unit 311 displays the comment data 741 (see FIG. 12A or the like). If, for example, the user has selected the handwritten comment 721 in FIG. 12A, the electronic bulletin board display unit 311 displays the electronic comment information 741 (character string “DEF”) at the same coordinates as those of the electronic input form 730 (−Xw1+Δx1, Yw1+Δy1). In addition, assume that the handwritten comment 721 is selected by user designation and the electronic input form 730 is displayed. In this case, if the content input to the electronic input form is a reference file, the electronic bulletin board display unit 311 displays a reference file access button 742. If, for example, the user has further selected the handwritten comment 721 in FIG. 12A, the electronic bulletin board display unit 311 displays the reference file access button 742 at coordinates (−Xw1+Δx1+Δx2, Yw1+Δy1) of a predetermined position shifted from the coordinates at which the electronic input form 730 is displayed, as shown in FIG. 12B.

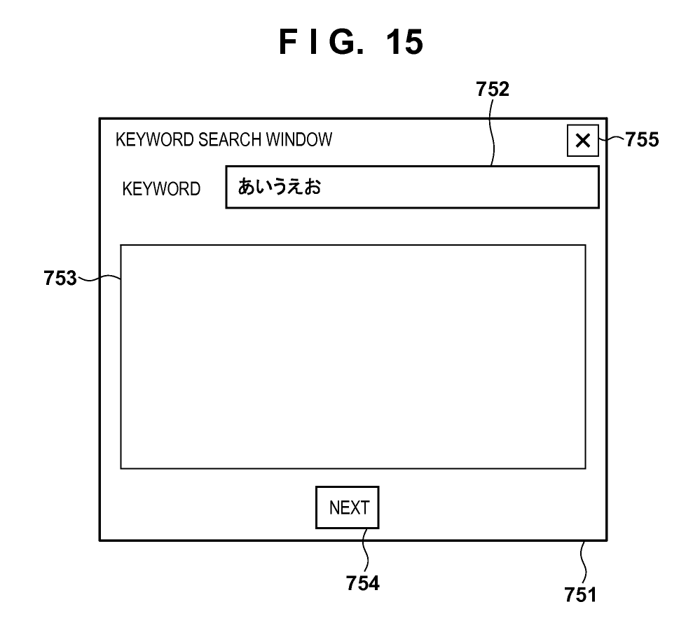

FIG. 15 explains a search engine window 751. On the search engine window 751, the character string input to the character string input region 731 is displayed in a keyword field 752. A search result is displayed in a search result file 753. A “next” button 754 is used to display a search result on the next page. A “hide” button 755 is used to close the search engine window.

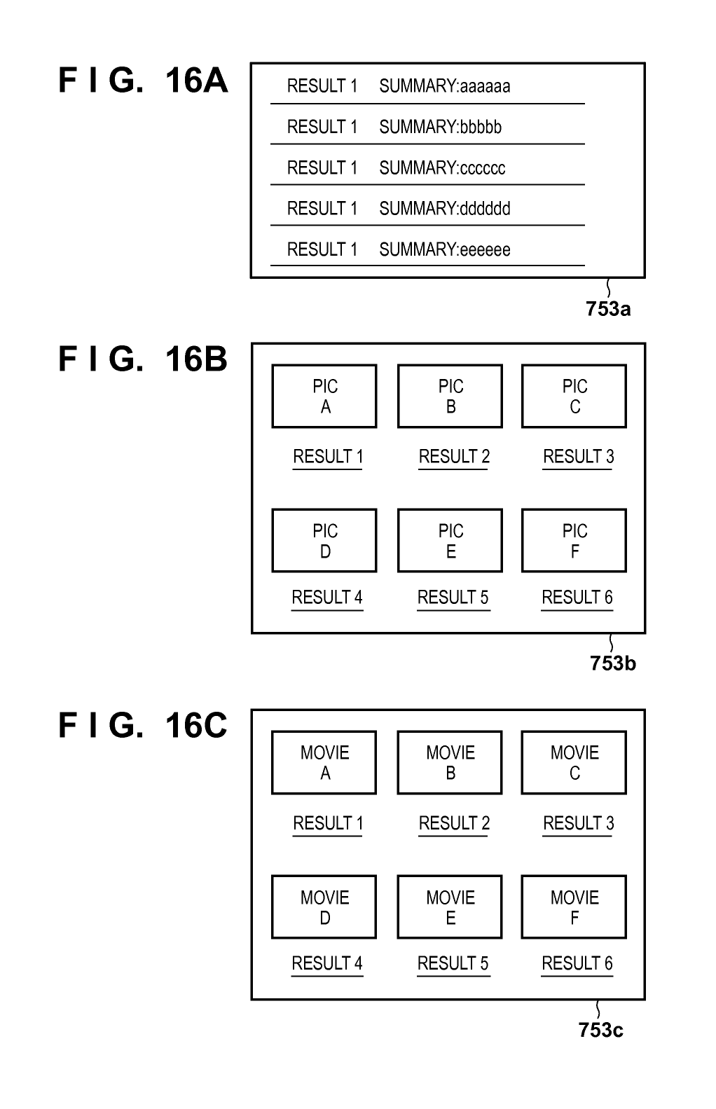

FIGS. 16A to 16C explain the search result file 753. An image 753a indicates a keyword search result example. An image 753b indicates an image search result example. An image 753c indicates a moving image search result example.

FIG. 17 explains a reference file path input window 761. A reference file path input field 762 is used to input a reference file to be attached. An attach button 763 is used to determine to attach the reference file input to the reference file path input field 762. A cancel button 764 is used to close the reference file path input window. In this embodiment, a reference file path is a path to a file stored in the storage unit 303 of the information terminal 300. However, the embodiment configured to upload (transmit) a file from the information terminal 300 to the server 400 while transmitting a reference file path may have the following arrangement. That is, when transmitting a reference file path to the reference file server 400, the reference file input unit 313 uploads the reference file path to the storage unit 403 of the server 400 to convert the reference file path into a path to the upload destination of the reference file and transmit the path. With this operation, the reference file is uploaded to the server 400 and the path to the file is stored. This makes it possible to refer to the reference file from any information terminals 300.

(Thread Information)

FIGS. 18A to 18F explain thread information managed by the thread management unit 413 (see FIG. 2C) in the server 400. The thread management unit 413 manages a plurality of pieces of thread information. One thread information is expressed by a tree structure constituted by one thread header and one or more pieces of comment information or 0 or more pieces of reference file information.

Thread header information 801 includes the following information.

Thread ID: A thread ID is information for uniquely specifying a thread and is a thread identifier.
First comment ID: A first comment ID indicates the comment ID of the first comment information of the thread.
Thread coordinate (Xthread): A thread coordinate (Xthread) indicates the Xthread coordinate of the thread information displayed in the electronic bulletin board coordinate system (Xbbs, Ybbs).
Thread coordinate (Ythread): A thread coordinate (Ythread) indicates the Ythread coordinate of the thread information displayed in the electronic bulletin board coordinate system.
Thread size (XSIZEthread): A thread size (XSIZEthread) indicates the Xbbs-axis direction size of the thread displayed in the electronic bulletin board coordinate system.
Thread size (YSIZEthread): A thread size (YSIZEthread) indicates the Ybbs-axis direction size of the thread displayed in the electronic bulletin board coordinate system.

Comment information 802 includes the following information.

Comment ID: A comment ID is information for uniquely specifying a comment.
Parent comment ID: A parent comment ID is the comment ID of comment information which is the parent node of the comment. If the comment is the first comment, there is no parent node.
Child comment ID: A child comment ID is the comment ID of comment information which is a child node of the comment. Parent comment information can have a plurality of pieces of child comment information. A parent comment ID and child comment IDs can be collectively called comment parent-child information indicating the parent-child relationship between the comments.
Reference file ID: A reference file ID is the reference file ID of a reference file associated with the comment information. Comment information can have a plurality of pieces of reference file information. If the value of this ID is null, it can indicate that the file has no reference file information. A reference file ID can therefore be regarded as reference file presence/absence information indicating the presence/absence of a reference file.
Type: A type is the identifier of a comment type which indicates whether the type of the comment information is a bitmap as a handwritten comment or a character string as an electronic comment.
Data: Data is a bitmap file name if the type is handwritten comment information and character string data if the type is electronic comment information.
Comment coordinate (Xcom): A comment coordinate (Xcom) indicates the Xbbs-coordinate of the comment information displayed in the electronic bulletin board coordinate system.
Comment coordinate (Ycom): A comment coordinate (Ycom) indicates the Ybbs-coordinate of the comment information displayed in the electronic bulletin board coordinate system.
Comment size (XSIZEcom): A comment size (XSIZEcom) indicates the Xbbs-axis direction size of the comment displayed in the electronic bulletin board coordinate system.
Comment size (YSIZEcom): A comment size (YSIZEcom) indicates the Ybbs-axis direction size of the comment displayed in the electronic bulletin board coordinate system. A comment size (XSIZEcom) and comment size (YSIZEcom) are used when the type of comment information is a bitmap. If the type is a character string, a character string size is calculated from the character size defined on the server 400 side. In this case, comment size information is a comment display size when the comment is displayed.
Superimposition target: Superimposition target information indicates whether the comment information is set as a superimposition display target. Comment information may always be set as a superimposition display target on the server side or information from the first comment ID up to N comments may be set as superimposition targets. This maximum number N may be set by the numerical value input based on user designation. In comment information 805b in FIG. 18E (to be described later), N=3.

Reference file information 803 includes the following information.

Reference file ID: A reference file ID is information for uniquely specifying reference file information.
Parent comment ID: A parent comment ID is the comment ID of comment information which is a parent node of the reference file information. That is, this can be regarded as associated comment information indicating comment information associated with the reference file information.
Type: A type indicates the type of the reference file information. Types include, for example, moving image information, voice information, document information, drawing information, URL information, and shortcut information. These pieces of information can be reproduced by corresponding applications.
Data: Data indicates the reference file path of reference file information. That is, this data is reference file data.
Access button coordinate (Xacc): An access button coordinate (Xacc) is the Xbbs-coordinate of an access button for the reference file information displayed in the electronic bulletin board coordinate system.
Access button coordinate (Yacc): An access button coordinate (Yacc) is the Ybbs-coordinate of an access button for the reference file information displayed in the electronic bulletin board coordinate system.
Access button size (XSIZEacc): An access button size (XSIZEacc) indicates the Xbbs-coordinate direction size of the access button for the reference file information displayed in the electronic bulletin board coordinate system.
Access button size (YSIZEacc): An access button size (YSIZEacc) indicates the Ybbs-coordinate direction size of the access button for the reference file information displayed in the electronic bulletin board coordinate system. The access button may be a reference file icon. In this case, the coordinates and size can be regarded as reference file icon display coordinates indicating the display position of the reference file icon and reference file icon display size information indicating the display size of the reference file icon, respectively.

A thread 804 is an example of the tree structure of thread information. The thread 804 is formed based on one thread header, five pieces of comment information, and three pieces of reference file information. The comment information with comment ID=3 includes two pieces of child comment information with comment ID=4 and comment ID=5. The comment information with comment ID=4 includes two pieces of reference file information with reference file ID=2 and reference file ID=3.

Thread header information 805a is an example of the thread header of the thread 804. The comment information 805b is an example of a list of comment information of the thread 804. Reference file information 805c is an example of a list of reference file information of the thread 804. In this case, parent comment ID=0 indicates that this comment information is the first comment information having no parent comment information. Child comment ID=0 indicates that this comment information is terminal comment information having no child comment information. Reference file ID=0 indicates that this file has no reference file information. That is, comment information with parent comment ID=0 is the root of the comment tree, and comment information with child comment ID=0 and reference file information are leaves of the comment tree. Superimposition target=1 indicates that the corresponding information is a superimposition target. Superimposition target=0 indicates that the corresponding information is not a superimposition target.

(Feature Pattern Information)

FIGS. 19A and 19B explain feature pattern information managed by the feature pattern management unit 416 in the server 400. A feature pattern is information indicating a feature of a pattern extracted from original data. The feature pattern management unit 416 manages a plurality of pieces of feature pattern information 2601. More specifically, the feature pattern management unit 416 manages these pieces of information as a feature pattern information table including each feature pattern information as a record. One piece of feature pattern information includes the following information.

Feature pattern ID: A feature pattern ID is information for uniquely specifying a feature pattern.
Feature point information path: A feature point information path is a path to a file storing feature point information including the feature amount information of the feature points of the feature pattern.
x-direction relative position (Xm): An x-direction relative position is the x-direction relative position information of the feature pattern viewed from the thread linked to this feature point.
y-direction relative position (ym): An y-direction relative position is the y-direction relative position information of the feature pattern viewed from the thread linked to this feature point.
Associated threshold ID: This is the threshold ID of the thread linked to this feature pattern.

A feature pattern information table 2601a is an example of a feature pattern information table including feature pattern information linked to the thread 804 as a record.

(Thread Management)

FIG. 20 explains thread management processing in the server 400. The thread management unit 413 determines in step S4011 whether the addition of a comment has occurred. More specifically, upon receiving comment information (handwritten comment information and electronic comment information) or reference file information, the thread management unit 413 determines that the addition of a comment has occurred.

Upon determining that the addition of a comment has occurred, the thread management unit 413 determines in step S4012 whether it is necessary to generate a new thread. More specifically, if the coordinate information included in comment information is not information indicating the inside of the display region of each piece of comment information 802 in thread information stored in the storage unit 303 or information indicating the inside of the region of the reference file access button of the reference file information 803, the thread management unit 413 determines that it is necessary to generate a new thread. If the coordinate information included in the comment information is information indicating the inside of the display region of each pieces of comment information in the thread information stored in the storage unit 303 or indicating the inside of the region of the reference file access button, the thread management unit 413 determines that it is not necessary to generate a new thread.

Upon determining that it is necessary to generate a new thread, the thread management unit 413 generates a new thread by generating the new thread header 801 in step S4013. Note that the subsequent processing executed by the thread management unit 413 is processing associated with the information of the newly generated thread. If the thread management unit 413 determines that it is not necessary to generate a new thread, the subsequent processing executed by the thread management unit 413 is processing associated with the information of a corresponding existing thread.

The thread management unit 413 then determines in step S4014 whether the input comment information is handwritten comment information. More specifically, the comment type determination unit 411 refers to the comment identifier included in the input comment information to determine whether the comment information is handwritten comment information, and transmits the determination result to the thread management unit 413. The thread management unit 413 determines, based on the received determination result, whether the input comment information is handwritten comment information. If the input comment information is handwritten comment information, the thread management unit 413 converts, in step S4015, the input comment information into a thread information format so as to display the handwritten comment information in the form of a thread.

Upon determining in step S4014 that the input comment information is not handwritten comment information, the thread management unit 413 determines in step S4016 whether the input comment information is electronic comment information. More specifically, the comment type determination unit 411 refers to the comment identifier included in the input comment information to determine whether the comment information is electronic comment information, and transmits the determination result to the thread management unit 413. The thread management unit 413 then determines, based on the received determination result, whether the input comment information is electronic comment information. If the input comment information is electronic comment information, the thread management unit 413 converts, in step S4017, the input comment information into a thread information format to display the comment information as electronic comment information.

If the thread management unit 413 determines in step S4016 that the input comment information is not electronic comment information, it indicates that the input comment information is reference file information. In step S4018, therefore, the thread management unit 413 converts the reference file information into a thread information format to display the information in the form of a thread.

In step S4019, the thread management unit 413 adds the comment information converted into the thread information format (see reference numerals 802 and 803 in FIGS. 18B and 18C) or reference file information to the thread information as an input target, updates the thread header, and stores the thread information in the storage unit 403.

In step S4020, as in step S4012, the thread management unit 413 checks whether the currently processed thread is a new thread.

Upon determining in step S4020 that the thread is a new thread, the thread management unit 413 registers a feature pattern existing near the new thread in step S4021. More specifically, the thread management unit 413 inputs the thread information of the new thread and executes a feature pattern registration procedure in FIG. 11.

Note that the information terminal 300 sometimes reads out the thread information managed by the thread management unit 413 from the storage unit 403 of the server 400. In addition, the information terminal 300 sometimes reads out the original data stored in the storage unit 403, adds thread information to the data, and displays the resultant data on the display unit 304. In this case, the server 400 transmits the thread information stored in the storage unit 403 and the original data 700 to the information terminal 300. The control unit 302 of the information terminal 300 displays the original data 700 in the electronic bulletin board coordinate system and superimposes and displays the thread information on the original data 700.

More specifically, the control unit 302 obtains comment information and reference file information which are used to display one thread in accordance with the thread header of the thread information. The control unit 302 then generates a bitmap, a character string, or an image object of a reference file access button based on the obtained comment information and reference file data. The control unit 302 also obtains the coordinate information (comment coordinates and access button coordinates) and size information (a comment size and an access button size) of each of the comment information and the reference file information. The control unit 302 generates an image by combining the image object with the original data 700 to superimpose and display the generated image object on the original data 700, based on the obtained coordinate information and size information. The control unit 302 displays the composite image on the display unit 304. The image data obtained by combining data is an image with the respective pieces of information of the thread information (comment information and reference file information) being held in an input or display positional relationship when they are input, and is displayed as one thread in the form of a thread. This display will be referred to as thread display.

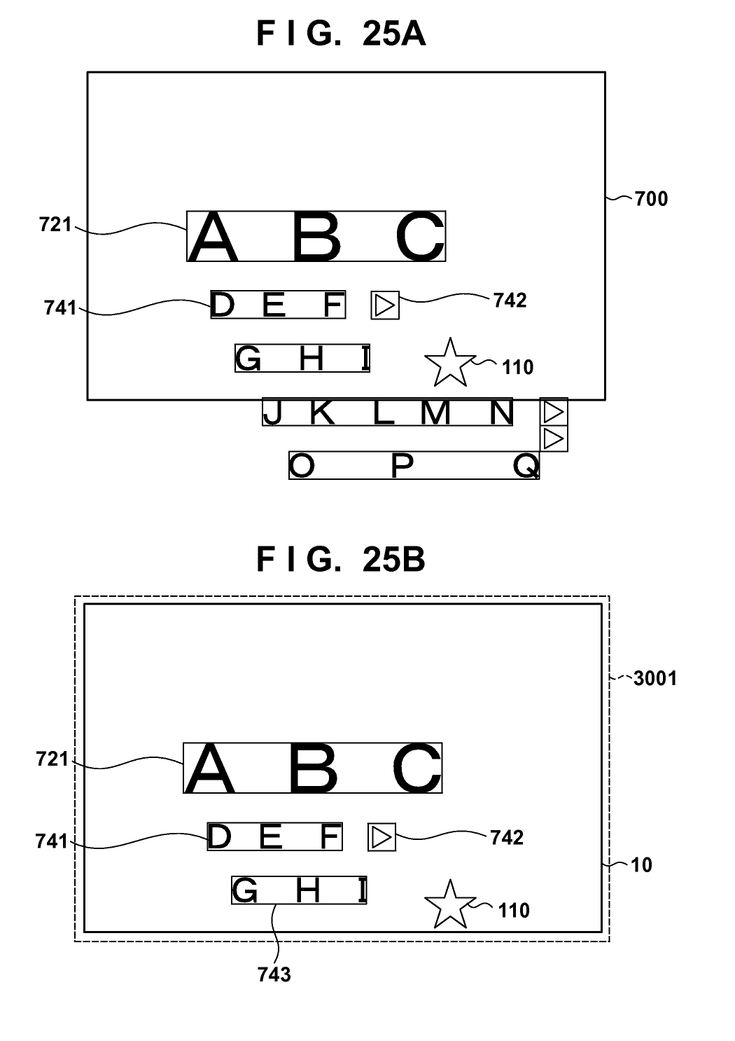

When the thread information (the thread header information 805a, comment information 805b, and reference file information 805c) in FIGS. 18D to 18F is displayed on the original data 700 in the form of a thread, the displayed image becomes an image like that shown in FIG. 25A. That is, when reading out thread information together with the original data 700 and displaying the information in the form of a thread, since there is no limitation on the size of a display window, the information terminal 300 displays all the contents of thread information in the form of a thread upon superimposing them on the original data 700. In such a case, the superimposition processing unit 315 sets the information of “superimposition target” of the comment information as “superimposition target=1” with respect to all the contents of thread information and displays the information in the form of a thread. This system may be configured to switch between displaying all the contents of the thread information or display part of the contents (for example, N comments from the first comment) based on user designation.

(Superimposition Display)

The electronic bulletin board system of this embodiment converts the handwritten comment input to the paper material 10 into electronic bitmap data. The display unit 304 of the information terminal 300 then displays the bitmapped handwritten comment together with the original data 700. The user who has added a handwritten comment to the handwritten comment or another user can add electronic comment via the information terminal 300.

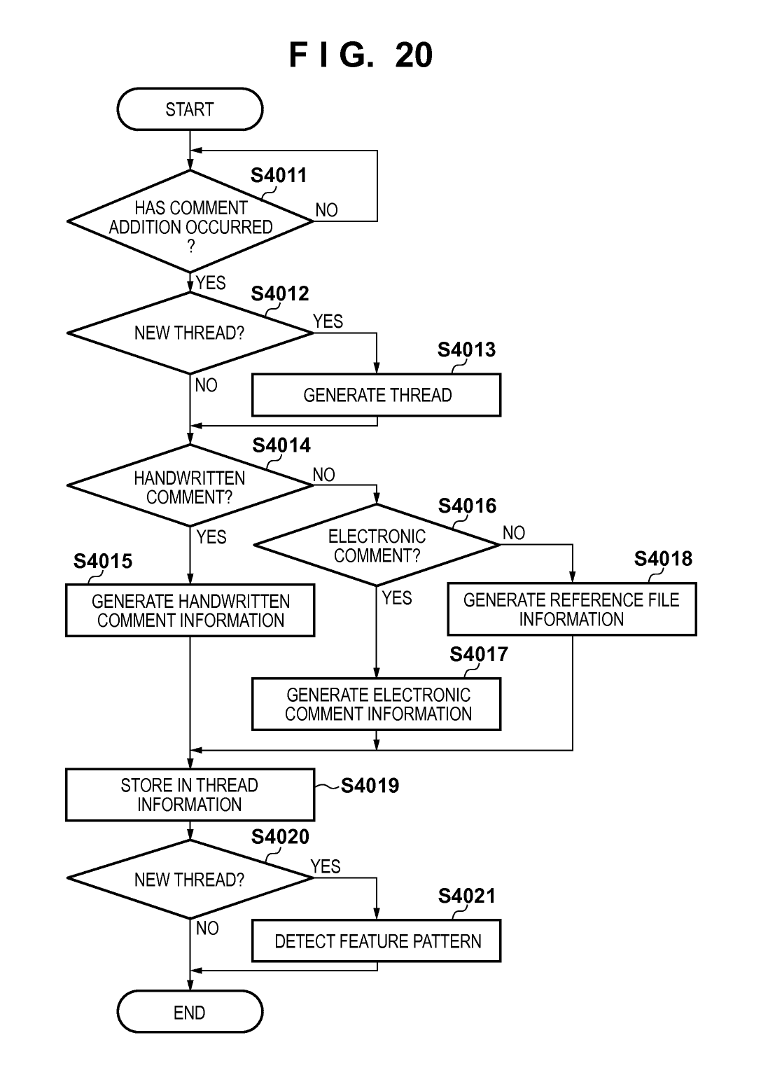

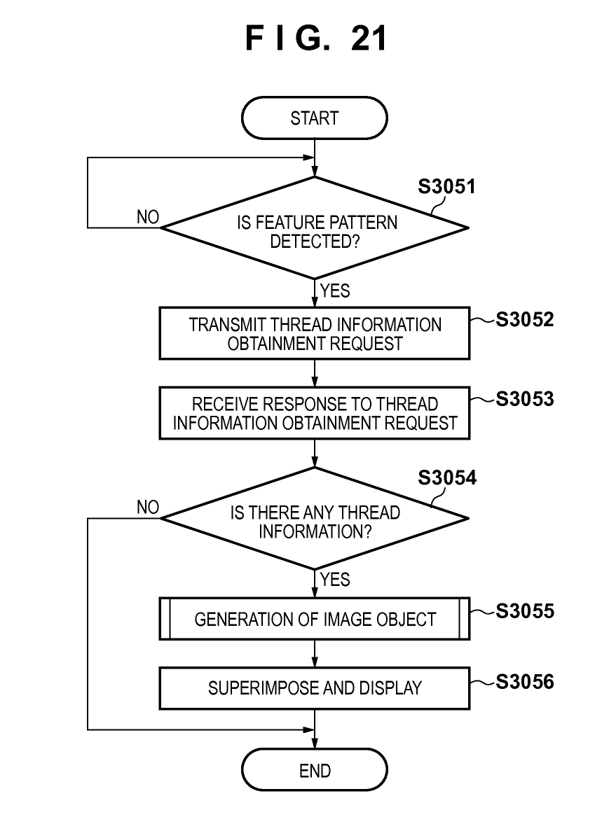

In this electronic bulletin board system, the user who has additionally handwritten a comment on the paper material 10 sometimes wants to see comments from other users. Alternatively, the user to which the paper material 10 before the addition of a handwritten comment has been distributed sometimes wants to see the handwritten comments or electronic comments which have already been added by other users. When the image sensing unit 306 of the information terminal 300 images the paper material 10 in order to cope with such a use case, the display unit 304 displays an image, with handwritten comments, electronic comments, and the like being superimposed on the captured image, in real time. This processing will be described with reference to FIGS. 21 to 25B.

FIG. 21 is a flowchart for explaining processing associated with superimposition display in the information terminal 300. With this processing, the information terminal 300 can superimpose and display thread information stored in the storage unit 303 on the image of the paper material 10, which is captured by the image sensing unit 306 and displayed on the display unit 304, based on the position of a feature pattern on the image.

In step S3050, the superimposition processing unit 315 downloads the feature pattern information table 2601a from the server 400 and stores the table in the storage unit 303.

In step S3051, the image sensing unit 306 images the paper material 10 and transmits the captured image (reference numeral 3001 in FIG. 25B) to the superimposition processing unit 315 of the control unit 302. The superimposition processing unit 315 of the control unit 302 determines whether a feature pattern 110 has been detected from a captured image 3001. Note that a feature pattern is a pattern which is detected to establish a correspondence relationship between the on-paper coordinate system and the electronic bulletin board coordinate system. This makes it possible to superimpose and display the bitmap and character string of comment information and image objects such as a reference file access button, which are managed in the electronic bulletin board coordinate system, at proper positions in the captured image 3001.

In order to detect a specific feature pattern from the captured image 3001, this embodiment uses a known feature point detection technique and feature amount extraction technique (for example, SURF). The superimposition processing unit 315 extracts feature amount information from a captured image by using these known techniques and compares the information with the feature amount information of each feature pattern in the feature pattern information table stored in the storage unit 303, thereby detecting a feature pattern. In this embodiment, a feature amount comparison method to be used is not limited to any specific method. For example, RANSAC may be used.

The superimposition processing unit 315 calculates the enlargement ratio of the feature pattern on the captured image relative to the feature pattern 710 on the original data while detecting the above feature pattern. The enlargement ratio is the size of the feature pattern on the window relative to the size of the feature pattern in the electronic bulletin board coordinate system.

Upon detecting a feature pattern, the superimposition processing unit 315 transmits a thread information obtainment request including the information of the feature pattern (feature pattern information) to the server 400 in step S3052. In addition, the superimposition processing unit 315 stores the position of the detected feature pattern on window coordinates in the storage unit 303.

In step S3053, the superimposition processing unit 315 receives information as a response to the transmission of the ID of the feature pattern information in step S3052 from the server 400.

In step S3054, the superimposition processing unit 315 determines whether the information received in step S3053 includes thread information. That is, the superimposition processing unit 315 determines whether it has received thread information.

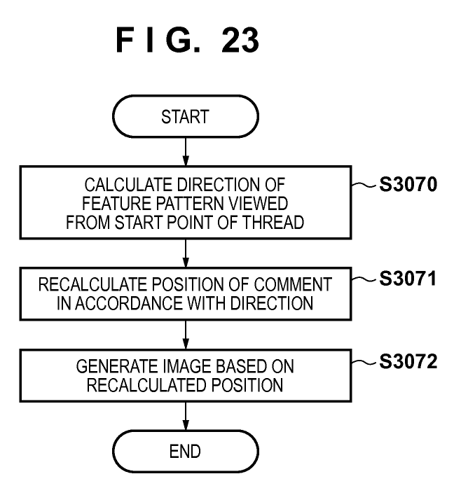

Upon determining the reception of thread information, the superimposition processing unit 315 generates an image object for superimposition display by using the received thread information and the position of the feature pattern obtained in step S3051 on the window in step S3055. This processing will be described later with reference to FIG. 23.

In step S3056, the superimposition processing unit 315 performs thread display by superimposing the generated image object at a position based on the detected position of the feature pattern on the image captured by the image sensing unit 306. To calculate the thread position on the window, the superimposition processing unit 315 multiplies a relative position (Xm, Ym) of the feature pattern information 2601 by the enlargement ratio obtained in step S3051 to match with the unit of coordinates on the window. The superimposition processing unit 315 then subtracts this relative position (Xm, Ym) from the position of the feature pattern obtains in step S3051.

The superimposition processing unit 315 draws the image object generated in step S3055 at the thread position upon enlarging/reducing the image object to match with the size on the window based on the enlargement ratio.

If the superimposition processing unit 315 determines in step S3054 that it has not received any thread information, the superimposition processing unit 315 generates no image object to be superimposed.

Note that in step S3051, the superimposition processing unit 315 may detect a plurality of patterns having high similarity degrees. In this case, the system may be configured to display a pattern with the highest similarity degree or present the respective pieces of thread information to the user to allow he/she to select which one of the pieces of thread information is superimposed and displayed.

FIG. 23 explains a procedure for generating an image object expressing a thread based on thread information and the feature pattern information 2601. The superimposition processing unit 315 of the information terminal 300 executes this procedure.

In step S3070, the superimposition processing unit 315 checks, from the signs of the values of the x-direction relative position and y-direction relative position of the feature pattern information 2601, whether the position of the feature pattern is in the upper right direction, lower right direction, upper left direction, or lower left direction relative to the position of the start point (start position) of the thread. If, for example, the x-direction relative position is positive and the y-direction relative position is positive, the superimposition processing unit 315 determines that the position of the feature pattern is in the lower right direction. If the signs of the above values are opposite, the resultant pattern is reversed horizontally and vertically.

In step S3071, the superimposition processing unit 315 recalculates the position of the comment included in the thread information so as to set a positional relationship in which the comment extends toward the feature pattern. As shown in FIG. 3, the coordinates of a comment are defined so as to have positive values on the right side in the x direction and on the lower side in the y direction. Every time an electronic comment is added, it is moved by (Δx1, Δy1). The following is a case in which Δx1 and Δy1 are positive values. If Δx1 and Δy1 are positive values, the thread extends in the lower right direction. If a feature pattern is located in a direction other than the lower right direction, the superimposition processing unit 315 recalculates one or both of the x-coordinate and y-coordinate coordinates of each comment information 802 in accordance with the direction of the feature pattern so as to make the comment symmetrical to the first comment (the comment without parent comment) with respect to the central position as an origin on the left side in the longitudinal direction.

In step S3072, the superimposition processing unit 315 generates an image object of the comment information 802 as a superimposition display target based on the information of the “superimposition target” included in the comment information 802 for each comment information 802 having recalculated coordinates. If the comment information is not a superimposition display target, the superimposition processing unit 315 draws the first comment of the thread as a processing target as an object having a transparence of 100%. When generating an image object of comment information, the superimposition processing unit 315 generates an image object of the reference file access button with respect to reference file information having, as a parent comment ID, the comment ID of comment information as a superimposition display target. The superimposition processing unit 315 does not generate an image object of the reference file access button with respect to reference file information having, as a parent comment ID, the comment ID of comment information which is not a superimposition display target, and does not handle the file information as a superimposition target. The superimposition processing unit 315 generates an image object in the above manner such that the image object is displayed so as to hold the positional relationship between comment information and file information based on the respective pieces of coordinate information in the thread information. That is, as shown in FIG. 25B, the handwritten comment 721, the electronic comments 741 and 743, and the reference file access button 742 are arranged in the form of a thread.

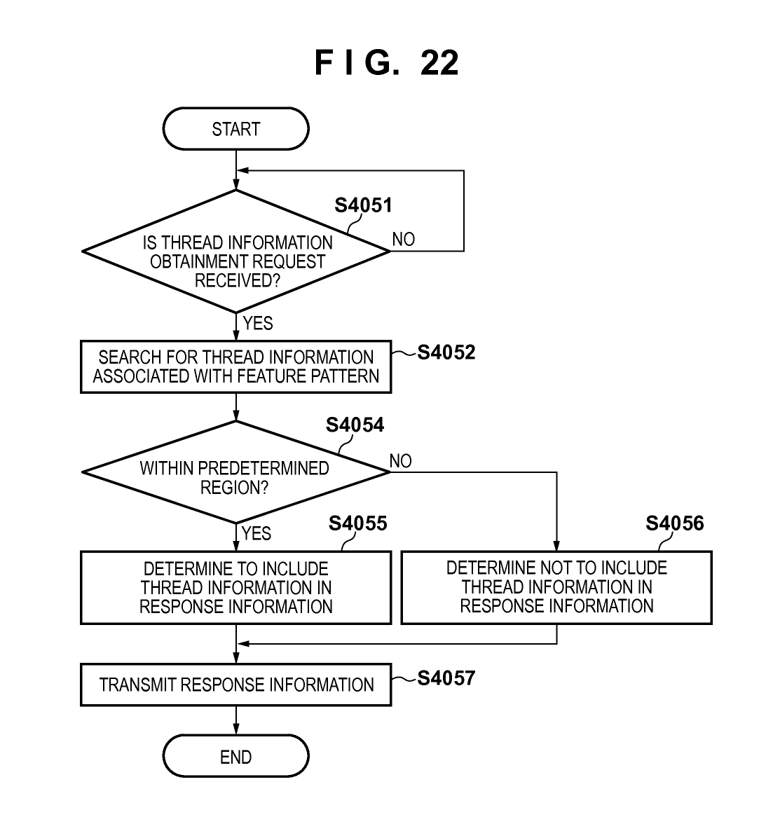

FIG. 22 is a flowchart for explaining processing in the server 400 which processes the thread information obtainment request transmitted in step S3052 in FIG. 21. In step S4051, the control unit 402 determines whether it has received the thread information obtainment request in step S3052 from the information terminal 300. The thread information obtainment request includes the information of a feature pattern detected by the superimposition processing unit 315.

Upon receiving the thread information obtainment request, the control unit 402 causes the feature pattern management unit 416 to search, in step S4052, for thread information corresponding to the received feature pattern information by using the feature pattern information table.

In step S4054, the control unit 402 determines whether the region of the nearest thread information exists within a predetermined distance relative to the feature pattern (pattern 710). More specifically, the control unit 402 determines whether the distance between the thread coordinates of the thread header included in the nearest thread information and the coordinates of the region extracted in step S4052 in the electronic bulletin board coordinate system is equal to or less than a predetermined threshold.

Upon determining in step S4054 that the region exists, the control unit 402 determines in step S4055 that it will include the thread information as the search result obtained in step S4052 in information as a response to the thread information obtainment request received in step S4051. Upon determining in step S4054 that the region does not exists, the control unit 402 determines in step S4056 that it will not include the thread information in information as a response to the thread information obtainment request received in step S4051.

In step S4057, the control unit 402 transmits the information as the response to the thread information obtainment request to the information terminal 300 in accordance with the decision made in step S4055 or S4056.

Executing the processing in FIGS. 21 and 22 described above can perform thread display of a handwritten comment, an electronic comment, and a reference file access button with respect to the image 3001 captured by the image sensing unit 306 as shown in FIG. 25B. This allows the user to easily obtain an electronic comment added to a handwritten comment by only imaging the paper material 10. In addition, since these comments are displayed in the form of a thread, the user can easily grasp the relationship between comments.

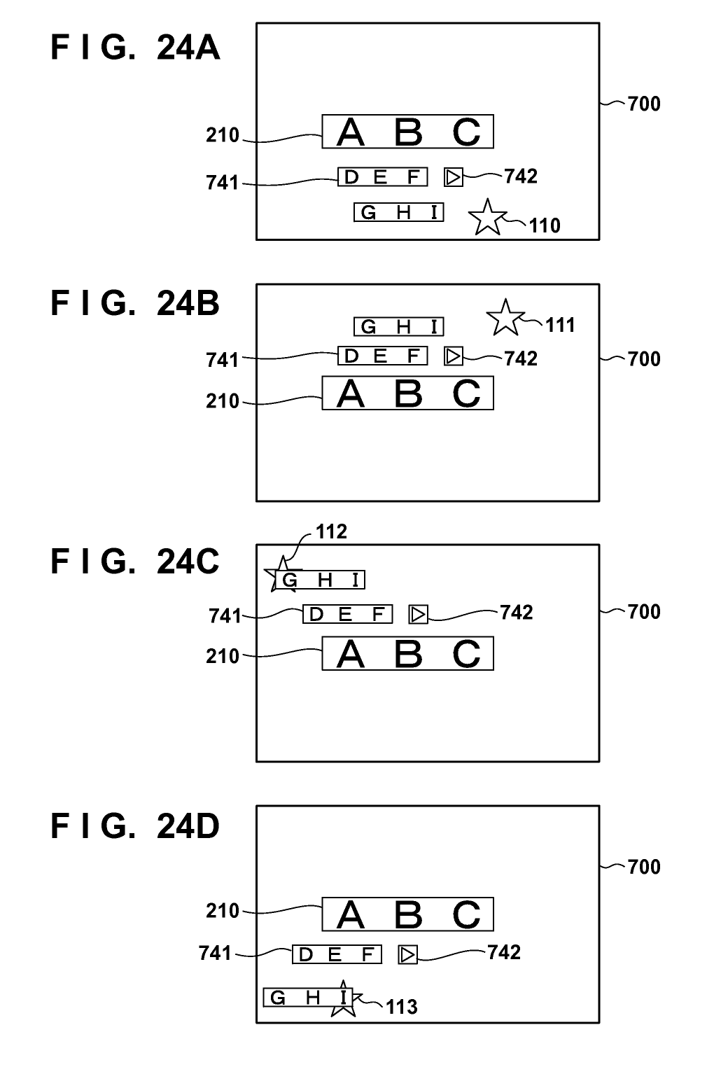

FIGS. 24A to 24D respectively show thread displays when feature patterns exist at a lower right position 110, an upper right position 111, an upper left position 112, and a lower left position 113. Handwritten characters 210 are a character string actually written on paper with the ink of a pen. As shown in FIGS. 24A to 24D, changing the extending direction of a thread in accordance with the existing position of a feature pattern allows the user to easily direct the camera to the region where the feature pattern exists. This makes it possible for the user to avoid invalidation of superimposition display due to a feature pattern dropping off a captured image without any specific consciousness. If, for example, a feature pattern exists at the upper left position 112 as shown in FIG. 24C, simply extending the thread to the lower right may make the user direct the camera to the lower right to try to read ahead of the thread. As a consequence, the feature pattern 710 is not included in the captured image, resulting in a failure to perform superimposition display. As in this embodiment, extending the thread to the upper left will make it difficult to lead to a situation in which the feature pattern 710 is not included in the captured image, even if the user directs the camera to the upper left to read ahead of the thread, because the feature pattern 710 exists in the direction.

Note that the processing procedures in FIGS. 21 and 22 described above are processing procedures to be executed when the information terminal 300 superimposes and displays thread information on the image captured by the image sensing unit 306. An image like that shown in FIG. 25B is displayed on the display unit 304. In this case, the information terminal 300 may have a mode selection unit which selects between a display mode of superimposing and displaying thread information on the original data 700 as shown in FIG. 25A described above and a display mode of superimposing and displaying thread information on the captured image 3001 as shown in FIG. 25B.

Note that this can be applied to a case in which many original data and printed materials are used. This can be implemented by preparing a plurality of electronic pens and one-to-one associating printed materials of the respective original data with electronic pens.

With the above arrangement and procedures, by using a portable terminal with a camera, the user superimposes and displays an electronic comment on the paper material image displayed on the display of the portable terminal while imaging the paper material. A handwritten comment is written on the paper material and the corresponding locus information is input. This system detects a feature pattern near the input position of the handwritten comment from the captured image in real time by using the image detection technique, stores/manages the electronic comment input in association with the detected feature pattern, and superimposes/displays the comment. This solves the problem of difficulty in associating with handwritten comments, that is, difficulty in extracting feature points because electronic comments are not directly associated with the handwritten characters of handwritten comments, character colors are thin, and character shapes are round.

Even if, therefore, a handwritten comment to be a trigger for superimposition display is spaced apart from a feature pattern which is used as an actual trigger, since the positional relationship between the feature pattern and the electronic comment is maintained, it is possible to display the electronic comment as desired by the user.

These can solve the problem of difficulty in grasping the relationship between a handwritten comment and an electronic comment in an image when the user refers to the comments afterward.

### Other Embodiments

Although the above embodiment uses the method of inputting handwritten comment information by coordinate calculation using the electronic pen 100 which generates ultrasonic waves, other methods may be used. That is, the following method may be used. The user writes with electronic pen on special paper on which a predetermined dot pattern is written. The image sensing unit attached to the electronic pen then reads the dot pattern corresponding to a locus. The server stores the dot pattern information of the special paper in advance. Based on the locus information transmitted from the electronic pen, the electronic bulletin board coordinate system generates a bitmap of a handwritten comment.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-270706, filed Dec. 11, 2012, which is hereby incorporated by reference herein in its entirety.

What is claimed is:

1. An information processing system comprising:
a handwritten comment input unit configured to input handwritten comment information to a printed material obtained by printing an original image, together with coordinate information of the handwritten comment information;
an electronic comment input unit configured to input electronic comment information to the handwritten comment information based on user designation;
a thread management unit configured to manage handwritten comment information input by said handwritten comment input unit and electronic comment information input by said electronic comment input unit, as thread information, in association with each other;
a feature pattern management unit configured to detect feature pattern information of a pattern existing near the thread information in the original image and manage the feature pattern information and the thread information in association with each other; and
a thread display unit configured to perform thread display of thread information managed by said thread management unit on an image obtained by imaging the printed material, wherein the thread display of the thread information is displayed from a position of a start point of the thread information toward the pattern.

2. The system according to claim 1, further comprising an input form display unit configured to display an electronic input form upon detecting an input start event for the thread display of the thread information displayed by said thread display unit and hide the electronic input form upon detecting an input end event.

3. The system according to claim 2, wherein said input form display unit displays the electronic input form at a position where the thread information and the electronic input form do not overlap upon detecting an input start event for the thread information.

4. The system according to claim 2, wherein the input form includes a character string input portion which accepts a character string input, a search portion which searches with a character string input by the character input portion, and an attachment portion which attaches a reference file.

5. The system according to claim 4, wherein said electronic comment input unit inputs a character string input by the character string input portion of the electronic input form as an electronic comment.

6. The system according to claim 4, wherein said electronic comment input unit inputs a reference file from the attachment portion of the electronic input form and generates a reference file icon for accessing the reference file.

7. The system according to claim 1, wherein, when detecting an input start event for a region which does not include the thread display of the thread information displayed by said thread display unit, said thread management unit newly generates thread information and determines an input to the generated thread information, and
wherein, when detecting an input start event for a region which includes the thread display of the thread information displayed by said thread display unit, said thread management unit determines an input to the thread information without newly generating thread information.

8. The system according to claim 1, wherein said thread management unit updates the thread information in each of cases in which a handwritten comment is input by said handwritten comment input unit, an electronic comment is input by said electronic comment input unit, and a reference file is input by said reference file input unit.

9. The system according to claim 1, wherein the thread information includes one thread identifier for identifying a thread, and comment information constituted by at least one handwritten comment or at least one electronic comment,
the thread information further includes reference file information optionally,
the comment information includes a comment identifier for identifying comment information, comment parent-child information indicating a parent-child relationship between comments, a reference file presence/absence information indicating the presence/absence of a reference file, comment data, coordinates at which a comment is displayed, and comment size information indicating a comment display size, and
the reference file information includes a reference file identifier for identifying reference file information, associated comment information indicating associated comment information, reference file data, icon display coordinates at which a reference file icon is displayed, and icon display size information indicating a display size of the reference file icon.

10. The system according to claim 1, wherein the thread information includes superimposition target information indicating whether comment information included in a thread is superimposed or not.

11. The system according to claim 1, further comprising a superimposition display unit configured to superimpose and display thread information on an image captured by an imaging sensing unit of an information terminal.

12. The system according to claim 11, further comprising a superimposition display unit configured to detect a feature pattern from the image captured by the image sensing unit of the information terminal and superimpose and display thread information corresponding to the detected feature pattern.

13. The system according to claim 10, wherein only a handwritten comment, an electronic comment, and a reference file which are indicated as superimposition display targets by the superimposition target information are superimposed and displayed.

14. The system according to claim 1, further comprising a generation unit configured to generate print data by combining the original image and the thread information.

15. An information processing method comprising:
inputting handwritten comment information to printed material obtained by printing an original image, together with coordinate information of the handwritten comment information;
inputting electronic comment information to the handwritten comment information based on user designation;
managing handwritten comment information input in the handwritten comment inputting step and electronic comment information input in the electronic comment inputting step, as thread information, in association with each other;
detecting feature pattern information of a pattern existing near the thread information in the original image and managing the feature pattern information and the thread information in association with each other; and
performing thread display of thread information managed in the thread management step on an image obtained by imaging the printed material, wherein the thread display of the thread information is displayed from a position of a start point of the thread information toward the pattern.

16. A non-transitory computer-readable storage medium storing a computer program for causing a computer to execute an information processing method defined in claim 15.
